(19) United States
(12) Patent Application Publication
(10) Pub. No.: US 2024/0202757 A1
(43) Pub. Date: Jun. 20, 2024

(54) PRIORITIZING AREAS AND OUTLETS USING GEO-ANALYTICS

(71) Applicant: Accenture Global Solutions Limited, Dublin (IE)

(72) Inventors: Amber KRISHNA, Noida (IN); Elisabeth Wendeline ELLISON-DAVIS, Lisboa (PT); Violeta TOFILAT, Singapore (SG); Vipoo GARG, Bangalore (IN)

(21) Appl. No.: 18/068,892

(22) Filed: Dec. 20, 2022

(51) Int. Cl. G06Q 30/0204

(52) U.S. Cl. CPC G06Q 30/0205

(57) ABSTRACT

In some implementations, a data visualizer may receive a raster file associated with a geographic area and generate tabular data based on the raster file. The data visualizer may receive a list of possible outlets and update a list of outlets based on removing duplicate outlets from the list of possible outlets. The data visualizer may generate a set of categories corresponding to the list of outlets based on a combination of master phrases, n-grams, and machine learning. The data visualizer may generate area scores, associated with subareas of the geographic area, based on the tabular data and indicated factors. The data visualizer may further generate outlet scores, associated with outlets in the list of outlets, based on the tabular data, the set of categories, and the indicated factors. The data visualizer may display, based on user input, a visual representation of the area scores or the outlet scores.

### BACKGROUND

Geographic visualization may be performed at various levels of granularity. For example, a geographic area may be divided and visualized by subarea. Alternatively, a geographic area may be visualized by individual points of interest included in the area.

### SUMMARY

Some implementations described herein relate to a method. The method may include receiving at least one raster file associated with a geographic area. The method may include generating tabular data based on the at least one raster file. The method may include receiving a list of possible outlets with a corresponding set of possible location indicators. The method may include updating a list of outlets, with a corresponding set of location indicators, based on removing duplicate outlets from the list of possible outlets. The method may include generating a set of categories corresponding to the list of outlets based on a combination of master phrases, n-grams, and machine learning. The method may include receiving an indication of one or more factors. The method may include generating one or more area scores, associated with one or more subareas of the geographic area, based on the tabular data and the one or more factors. The method may include generating one or more outlet scores, associated with one or more outlets in the list of outlets, based on the tabular data, the set of categories, and the one or more factors. The method may include displaying, based on user input, a visual representation of the one or more area scores or the one or more outlet scores.

Some implementations described herein relate to a device. The device may include one or more memories and one or more processors communicatively coupled to the one or more memories. The one or more processors may be configured to receive an indication of at least one statistical distribution associated with a geographic area. The one or more processors may be configured to receive at least one raster file indicating raster values associated with the geographic area. The one or more processors may be configured to receive a shape file indicating a set of polygons. The one or more processors may be configured to generate a set of masks based on the set of polygons to create attribute data. The one or more processors may be configured to standardize the attribute data based on the at least one statistical distribution. The one or more processors may be configured to generate tabular data based on standardizing the attribute data.

Some implementations described herein relate to a non-transitory computer-readable medium that stores a set of instructions for a device. The set of instructions, when executed by one or more processors of the device, may cause the device to receive a set of outlets with a corresponding set of location indicators. The set of instructions, when executed by one or more processors of the device, may cause the device to receive a possible outlet with a corresponding possible location indicator. The set of instructions, when executed by one or more processors of the device, may cause the device to determine a set of buffer zones corresponding to the set of outlets. The set of instructions, when executed by one or more processors of the device, may cause the device to classify the possible outlet as a new outlet based on the possible location indicator being located outside the set of buffer zones or based on information associated with the possible outlet failing to satisfy one or more fuzzy match criteria based on a set of information associated with the set of outlets.

### BRIEF DESCRIPTION OF THE DRAWINGS

FIGS. 1A-1E are diagrams of an example implementation described herein.

FIGS. 2A-2B are diagrams of an example implementation described herein.

FIGS. 3A-3B are diagrams of an example implementation described herein.

FIGS. 4A, 4B, 5A, 5B, 6A, 6B, 7A, 7B, and 7C are diagrams of example visualizations described herein.

FIGS. 8A, 8B, 9A, 9B, and 10 are diagrams of example visualizations described herein.

FIG. 11 is a diagram of an example visualization described herein.

FIG. 12 is a diagram of an example environment in which systems and/or methods described herein may be implemented.

FIG. 13 is a diagram of example components of one or more devices of FIG. 12.

FIG. 14 is a flowchart of an example process relating to fuzzy search and raster file procedures.

### DETAILED DESCRIPTION

The following detailed description of example implementations refers to the accompanying drawings. The same reference numbers in different drawings may identify the same or similar elements.

A geographic area (such as a country) may be visualized by subarea or by individual points of interest included in the area. For example, the United States may be visualized as divided into states or may be visualized by points of interest, such as particular restaurant or store locations. Generating such visualizations consumes power and processing resources at a computerized system. Additionally, generating the visualizations may consume network resources when the visualizations use information external to the computerized system. For example, the computerized system may receive information to visualize (e.g., demographic information for visualizing subareas) from an external database. Thus, in order to visualize differences between subareas, the computerized system generally receives and processes information associated with each subarea separately. For example, the computerized system may receive a separate table of demographic information for every subarea. As a result, the computerized system consumes significant amounts of network resources, power, and processing resources.

Additionally, points of interest may be indicated across multiple data sources. Accordingly, the computerized system may generate duplicate indicators in a visualization, which wastes power and processing resources. Additionally, the duplicate indicators increase a size of instructions for displaying the visualization, and thus the computerized system wastes network resources in transmitting the instructions to a user device.

Some implementations described herein enable raster file processing to estimate values associated with different subareas of a geographic area. As a result, a computerized system conserves network resources, power, and processing resources when generating a visualization associated with the subareas by reducing an amount of information that is received and processed. For example, the computerized system may process one raster file (or a few raster files) to generate estimates for each subarea rather than receiving and processing separate tables for every subarea. Additionally, or alternatively, some implementations described herein enable fuzzy search processes that eliminate duplicate points of interest. As a result, a computerized system conserves power, processing resources, and memory space when generating a visualization associated with the points of interests by reducing, or even eliminating, duplicates included in the visualization. Furthermore, fewer duplicates results in smaller instructions for displaying the visualization, and thus the computerized system conserves network resources in transmitting the instructions to a user device.

To allow for customizing which points of interest are displayed, the computerized system may use category tags associated with the points of interest. However, because the points of interest are indicated across multiple data sources, the category tags may vary significantly. Accordingly, a customized visualization may be missing points of interest with slightly different category tags, which results in wasted power and processing resources in generating the customized visualization, as well as wasted network resources in transmitting instructions for displaying the customized visualization to a user device.

Some implementations described herein enable uniform categorization and tagging using a combination of master phrases, n-grams, and machine learning. As a result, a computerized system conserves network resources, power, and processing resources when generating a customized visualization by standardizing category tags associated with points of interest indicated in the customized visualization. For example, the computerized system may standardize category tags, which reduces a quantity of possible customized visualizations and thus conserves power and processing resources in generating customized visualizations. Additionally, the computerized system conserves network resources in transmitting instructions for displaying the customized visualizations to a user device.

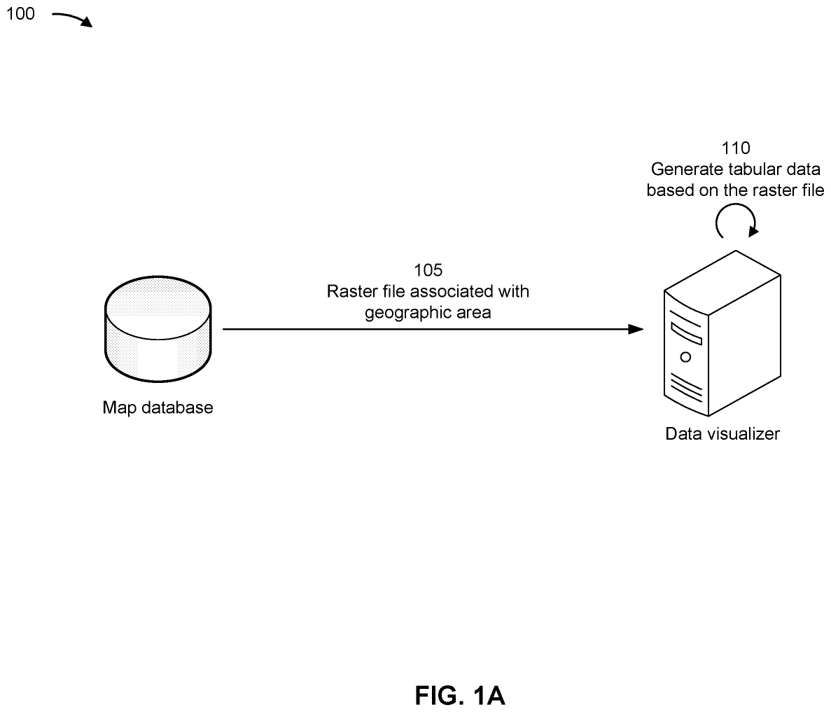

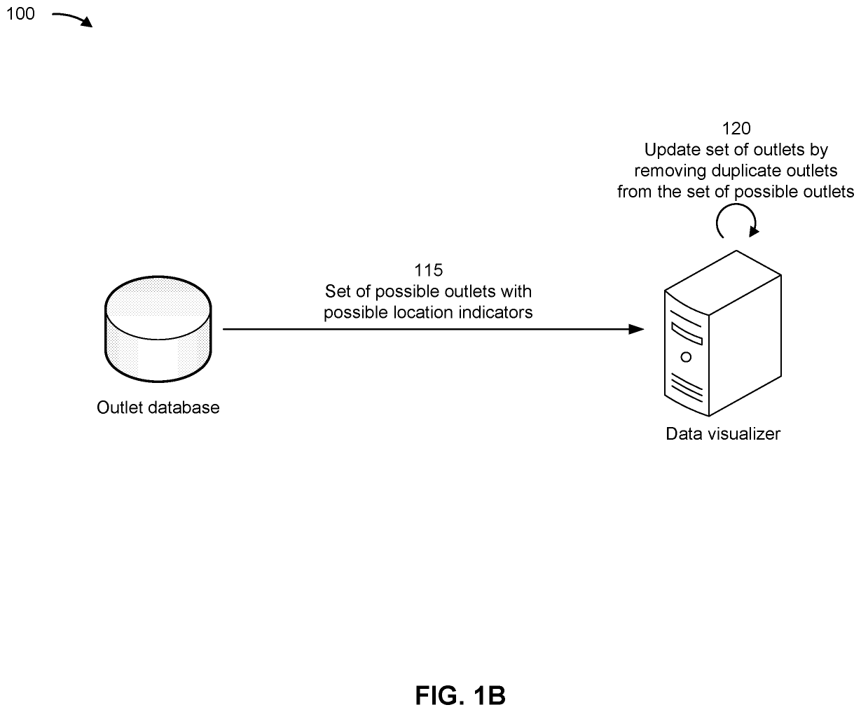

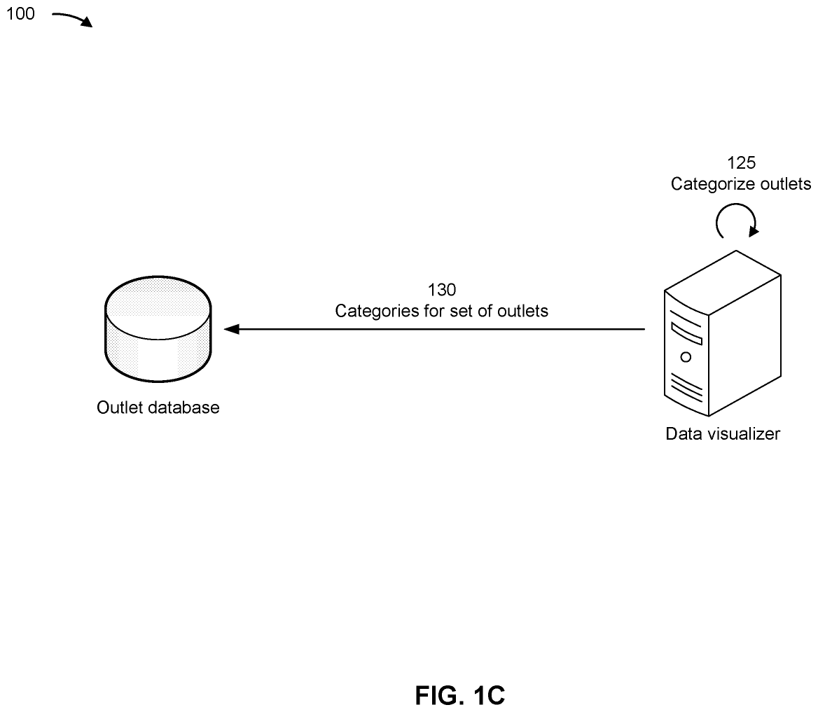

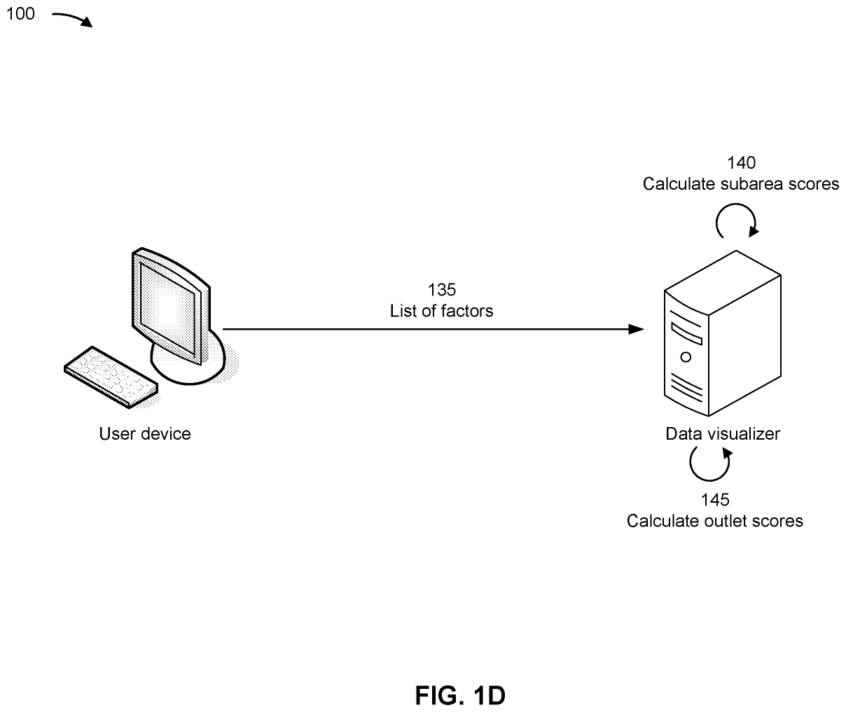

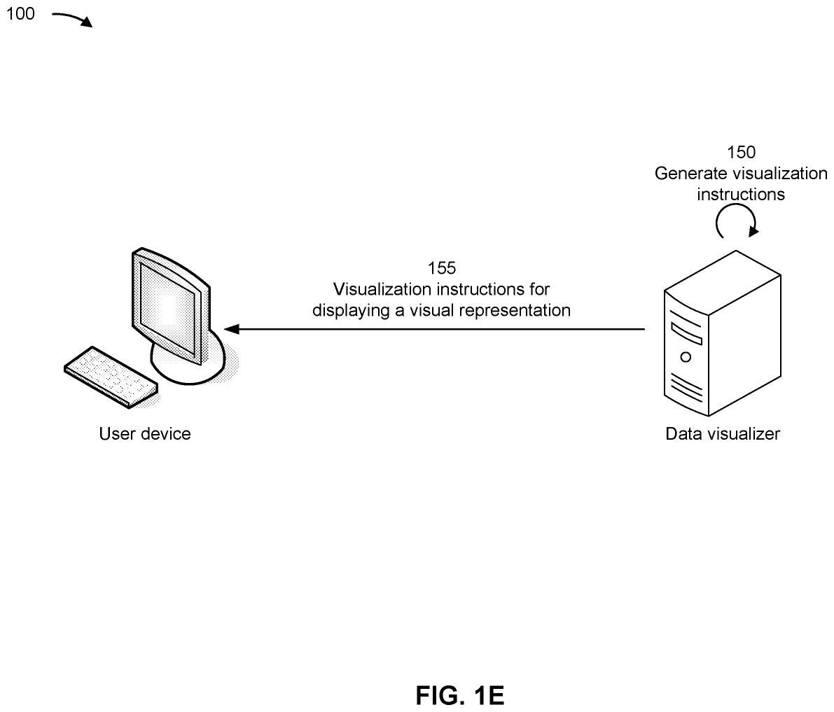

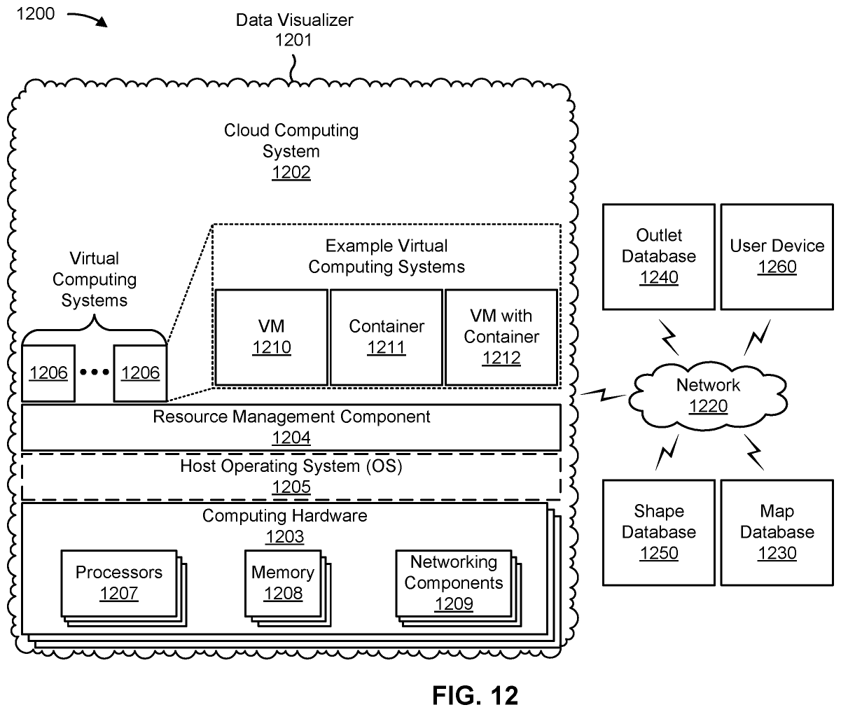

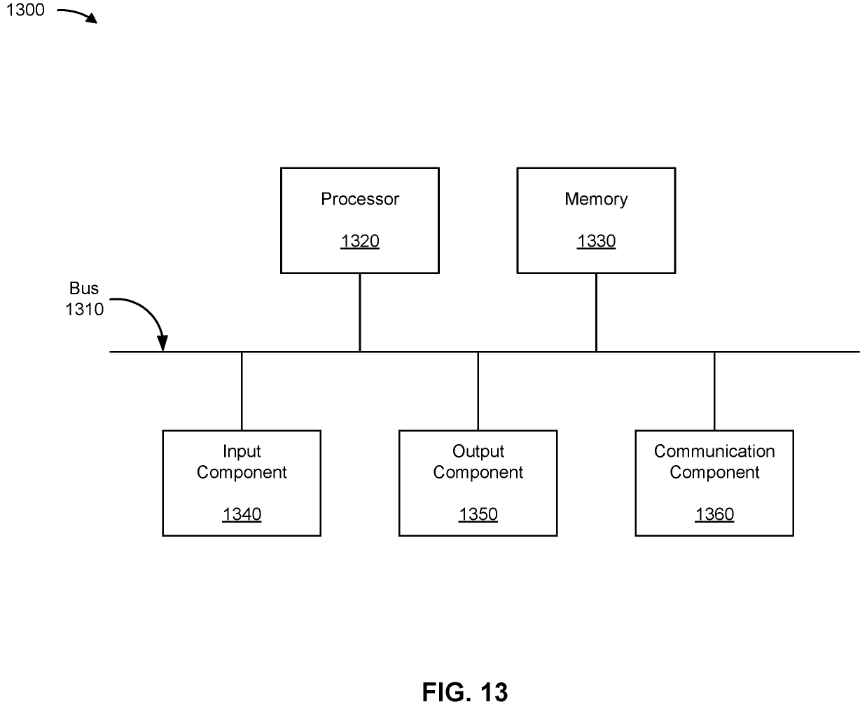

FIGS. 1A-1E are diagrams of an example implementation 100 associated with geographic visualization using fuzzy search and raster file procedures. As shown in FIGS. 1A-1E, example implementation 100 includes a data visualizer, a map database, an outlet database, and a user device. These devices are described in more detail below in connection with FIG. 12 and FIG. 13.

As shown in FIG. 1A and by reference number 105, the data visualizer may receive, from the map database, a raster file (e.g., at least one raster file) associated with a geographic area. The map database may be local to the data visualizer (e.g., a cache, a memory, and/or another type of local storage). Alternatively, the map database may be at least partially separate (e.g., physically, logically, and/or virtually) from the data visualizer. In some implementations, the map database and/or the data visualizer may convert a vector file (e.g., using PostScript or another similar type of software) to the raster file.

The data visualizer may transmit, to the map database, a request (e.g., a query, a hypertext transfer protocol (HTTP) request, an application programming interface (API) call, and/or another type of request) for the raster file (e.g., including a file name, an indication of the geographic area, or another type of identifier) in order to calculate tabular data (e.g., as described in connection with reference number 110). For example, the data visualizer may receive input (e.g., from the user device) requesting a visualization associated with the geographic area. Accordingly, the data visualizer may transmit the request for the raster file in response to the input requesting the visualization. The map database may transmit the raster file as a response to the request.

As shown by reference number 110, the data visualizer may generate tabular data based on the raster file. For example, the tabular data may include information regarding geo-spatial attributes associated with subareas (e.g., one or more subareas) of the geographic area. Accordingly, the tabular data may include quantities of apartments, train stations, schools, or other geo-spatial attributes associated with the subareas. Additionally, or alternatively, the tabular data may include socio-demographic attributes associated with the subareas. Accordingly, the tabular data may include quantities of men, women, high-income earners, households with children, or other socio-demographic attributes associated with the subareas.

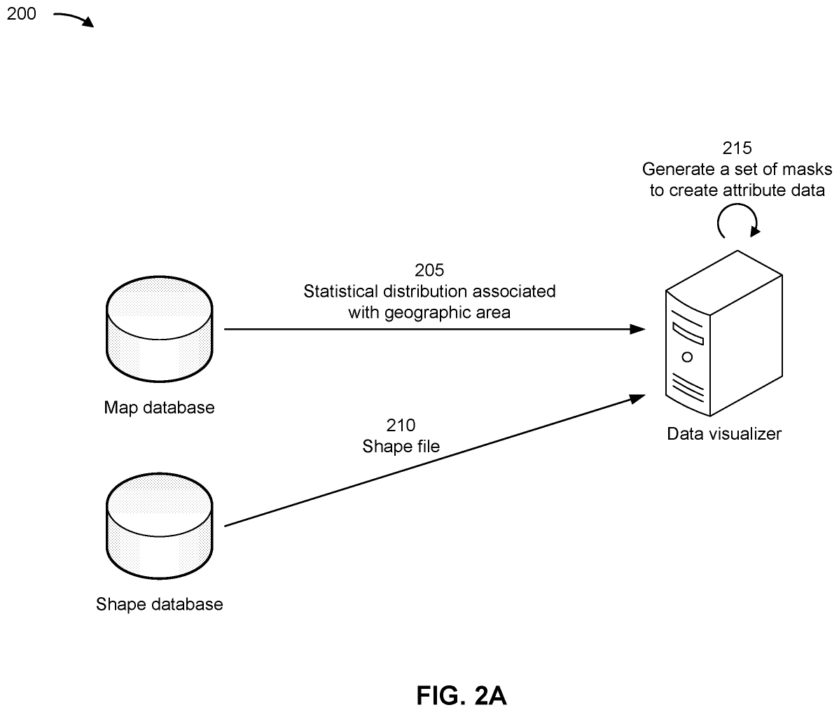

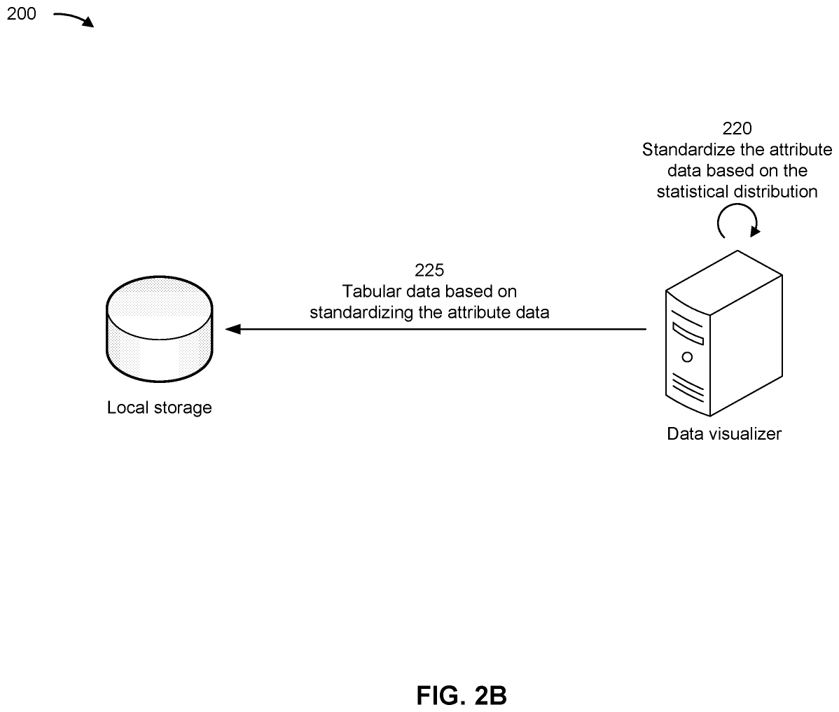

In some implementations, the data visualizer may generate the tabular data as described in connection with FIGS. 2A-2B. For example, the data visualizer may generate a set of masks, based on a set of polygons, to create attribute data (e.g., based on raster values indicated in the raster file). Each value in the attribute data may be associated with a corresponding mask of the set of masks. In some implementations, the data visualizer may further standardize the attribute data based on statistics associated with geographic areas and populate the tabular data based on standardizing the attribute data.

As shown in FIG. 1B and by reference number 115, the data visualizer may receive, from the outlet database, a list of possible outlets with a corresponding set of possible location indicators. The outlet database may be local to the data visualizer (e.g., a cache, a memory, and/or another type of local storage). Alternatively, the outlet database may be at least partially separate (e.g., physically, logically, and/or virtually) from the data visualizer. In some implementations, the outlet database and/or the data visualizer may convert tabular data, a comma-separate values (CSV) file, or another type of structure or unstructured data into the list of possible outlets.

The list of possible outlets may include a name (e.g., a string) for each outlet and a description (e.g., a string) for each outlet. The possible location indicators may include coordinates (e.g., in a geocentric coordinate system, a geodetic coordinate system, or a local tangent plane coordinate system, among other examples), street addresses, and/or other location indicators. The data visualizer may transmit, to the outlet database, a request (e.g., a query, an HTTP request, an API call, and/or another type of request) for the list of possible outlets (e.g., including an indication of the geographic area) in order to update an existing list of outlets (e.g., as described in connection with reference number 120). For example, the data visualizer may receive input (e.g., from the user device) requesting a visualization associated with the geographic area. Accordingly, the data visualizer may transmit the request for the list of possible outlets in response to the input requesting the visualization. The outlet database may transmit the list of possible outlets as a response to the request.

As shown by reference number 120, the data visualizer may update a list of outlets (e.g., an existing list, optionally paired with a corresponding set of location indicators) based on removing duplicate outlets from the list of possible outlets. Accordingly, remaining outlets in the list of possible outlets that are not classified as duplicate outlets may be added to (e.g., concatenated onto) the existing list of outlets. The list of outlets may be from another data source (e.g., a database local or at least partially external to the data visualizer) and/or may be previously processed and stored by the data visualizer.

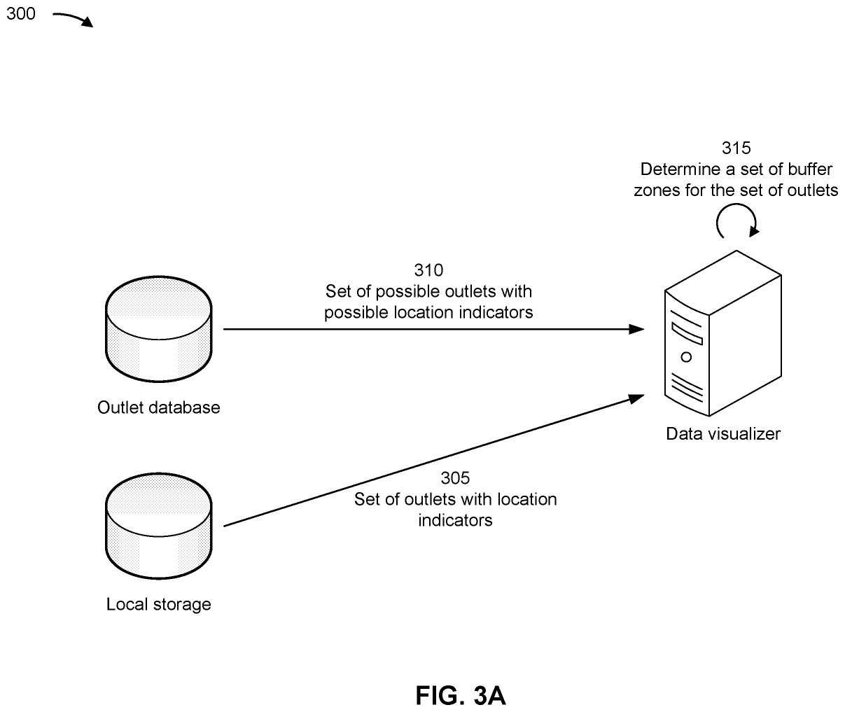

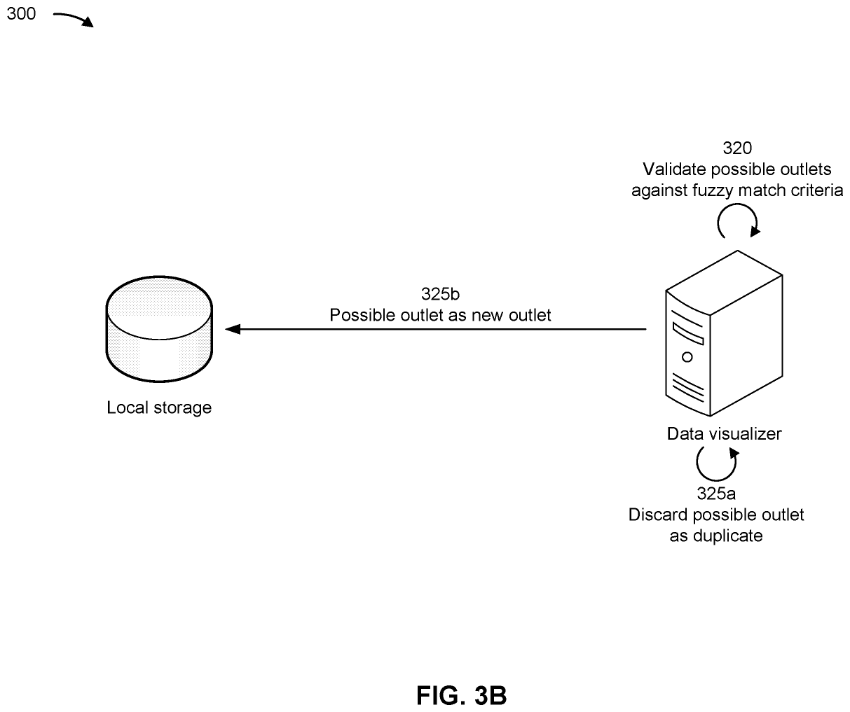

In some implementations, the data visualizer may update the list of outlets as described in connection with FIGS. 3A-3B. For example, the data visualizer may, for each outlet in the list of outlets, determine a buffer zone corresponding to the outlet. Accordingly, the data visualizer may remove a possible outlet, from the list of possible outlets, as a duplicate outlet based on a fuzzy match (e.g., a matching quantity of characters that satisfies a quantity threshold or a matching percentage of characters that satisfies a percentage threshold) between the possible outlet and an outlet in the list of outlets and/or based on the possible location indicator associated with the possible outlet being included in the buffer zone corresponding to the outlet (e.g., at least one buffer zone), as described in connection with reference number 325a of FIG. 3B. Similarly, the data visualizer may add a possible outlet, from the list of possible outlets, as a new outlet based on a lack of fuzzy match and/or based on the possible location indicator associated with the possible outlet being outside the buffer zones, as described in connection with reference number 325b of FIG. 3B.

As shown in FIG. 1C and by reference number 125, the data visualizer may generate a set of categories, corresponding to the list of outlets (as updated), based on a combination of master phrases, n-grams, and machine learning. The set of categories may include types of outlets, such as café, restaurant, grocery store, supermarket, pharmacy, or electronics store, among other examples. In some implementations, the set of categories is a nested list. For example, the category of café may be associated with subcategories including coffee, ice cream, juice, snack, or tea, among other examples. In another example, the category of restaurant may be associated with subcategories including chain, local, sit-down, or take-out, among other examples. Some categories may be associated with subcategories while other categories are not. Although described in connection with a single category and single subcategory, some implementations may generate a plurality of categories and/or a plurality of subcategories (if applicable) for an outlet.

The data visualizer may apply master phrases, n-grams, and machine learning in sequence. Accordingly, the data visualizer may apply a category tag (from a set of possible category tags) to an outlet when a description associated with the outlet matches (or includes) a master phrase associated with the category tag. For example, a category of “café” may be associated with a master phrase of “café,” a master phrase of “coffee shop,” and a master phrase of “coffee house,” among other examples. When the description fails to match (or include) any master phrase associated with the set of possible category tags, the data visualizer may apply a category tag (from the set of possible category tags) to the outlet when the description associated with the outlet includes an n-gram associated with the category tag. For example, a category of “café” may be associated with n-grams of “coffee,” “coffee-,” “coffee &,” “café,” “garden,” and “shop,” among other examples. In some implementations, the data visualizer may apply the n-grams when the description includes multiple master phrases associated with different possible categories. Accordingly, the data visualizer may select between the different possible categories (e.g., based on which of the possible categories is associated with more n-grams included in the description).

When the description fails to include any n-gram associated with the set of possible category tags, the data visualizer may apply a machine learning model to generate a category tag for the outlet. In some implementations, the machine learning model may include a regression algorithm (e.g., linear regression or logistic regression), which may include a regularized regression algorithm (e.g., Lasso regression, Ridge regression, or Elastic-Net regression). Additionally, or alternatively, the machine learning model may include a decision tree algorithm, which may include a tree ensemble algorithm (e.g., generated using bagging and/or boosting), a random forest algorithm, or a boosted trees algorithm. Additionally, or alternatively, the machine learning model may include a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm. The machine learning model may be trained to accept the description associated with the outlet as input and to output a suggested category tag (or a plurality of suggested category tags with a corresponding plurality of confidence values). In some implementations, the data visualizer may apply the machine learning model when the description includes multiple n-grams associated with different possible categories. Accordingly, output from the machine learning model may allow the data visualizer to select between the different possible categories (e.g., based on confidence values output by the machine learning model).

By using the master phrases, the n-grams, and the machine learning model in sequence, the data visualizer conserves power, processing resources, and memory by refraining from applying the n-grams when the description includes a master phrase and by refraining from applying the machine learning model when the description includes a master phrase or an n-gram. Additionally, by using the master phrases, the n-grams, and the machine learning model in sequence, the data visualizer increases accuracy of categorization for the outlets.

As shown by reference number 130, the data visualizer may store, in the outlet database, the set of categories corresponding to the list of outlets (as updated). The outlet database may include a tabular data structure or another type of relational data structure. Accordingly, the data visualizer may store an indication of each category in association with an identifier of the corresponding outlet for the category. Therefore, each entry in the outlet database may corresponding to an outlet in the list of outlets (as updated), and each entry may include an associated indication of the category for the outlet.

As shown in FIG. 1D and by reference number 135, the user device may transmit, and the data visualizer may receive, an indication of factors (e.g., one or more factors) to apply. The user device may transmit the indication of the factors with the input requesting the visualization associated with the geographic area, as described above. Alternatively, the data visualizer may transmit, and the user device may receive, a prompt in response to the input requesting the visualization associated with the geographic area. Accordingly, the user device may transmit, and the data visualizer may receive, a response to the prompt indicating the factors to apply. For example, the prompt may indicate a set of possible factors, and the response may indicate a subset, of the set of possible factors, to apply. The factors may include geo-spatial attributes and/or socio-demographic attributes, as described above.

In some implementations, the user device may transmit, and the data visualizer may receive, an indication of weights (e.g., one or more weights) associated with the factors. For example, the weights may include decimal values between 0.0 and 1.0 (or percentages between 0% and 100%) and indicate which factors to prioritize over other factors. The user device may transmit the indication of weights with the indication of the factors.

As shown by reference number 140, the data visualizer may generate scores (e.g., one or more scores) associated with subareas (e.g., one or more subareas) of the geographic area based on the tabular data and the factors. For example, the data visualizer may apply a formula that accepts values in the tabular data as input and outputs subarea scores. The values from the tabular data may be selected based on the subareas (e.g., selected by the user device) and the factors. For example, the data visualizer may select entries in the tabular data that correspond to the subareas indicated by the user device (e.g., in the input requesting the visualization associated with the geographic area, as described above). Additionally, the data visualizer may extract values, from the selected entries, corresponding to the factors (e.g., the geo-spatial attributes and/or socio-demographic attributes indicated by the user device). In some implementations, the formula may apply the weights indicated by the user device.

In some implementations, the data visualizer may receive supplemental information from an additional database (e.g., at least one database) local to the data visualizer or at least partially external to the data visualizer. For example, at least one value corresponding to one of the factors may be received from the additional database rather than the tabular data.

As shown by reference number 145, the data visualizer may generate scores (e.g., one or more scores) associated with outlets (e.g., one or more outlets in the list of outlets, as updated) of the geographic area based on the tabular data, the set of categories, and the factors. For example, the data visualizer may apply a formula that accepts values in the tabular data as input and outputs outlet scores. The values from the tabular data may be selected based on vicinities (e.g., one or more vicinities) associated with the outlets and the factors. For example, the data visualizer may select entries in the tabular data that correspond to the vicinities (e.g., calculated similarly as buffer zones described herein). Additionally, the data visualizer may extract values, from the selected entries, corresponding to the factors (e.g., the geo-spatial attributes and/or socio-demographic attributes indicated by the user device). In some implementations, the formula may apply the weights indicated by the user device.

In some implementations, the data visualizer may receive supplemental information from an additional database (e.g., at least one database) local to the data visualizer or at least partially external to the data visualizer. For example, at least one value corresponding to one of the factors may be received from the additional database rather than the tabular data.

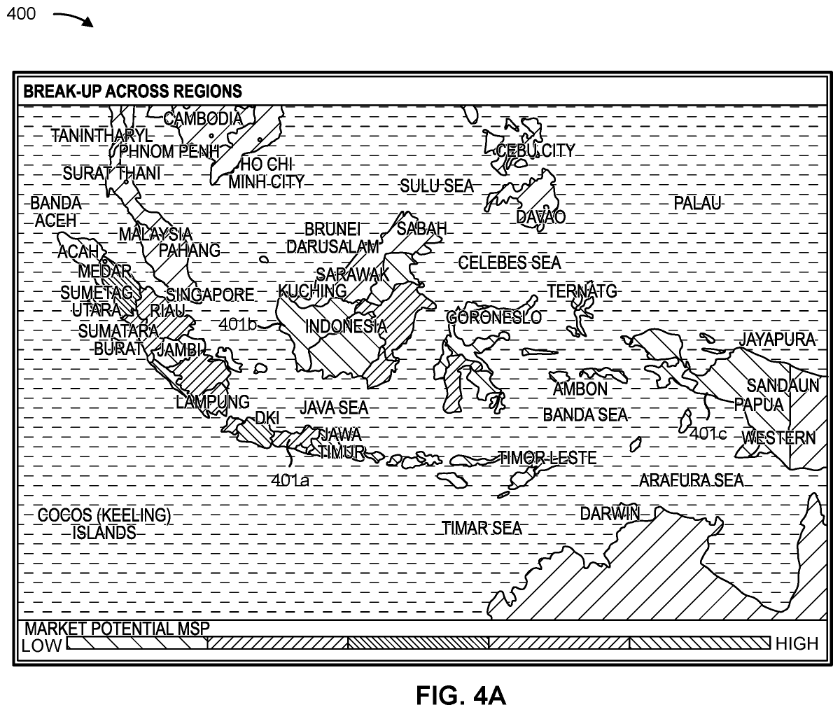

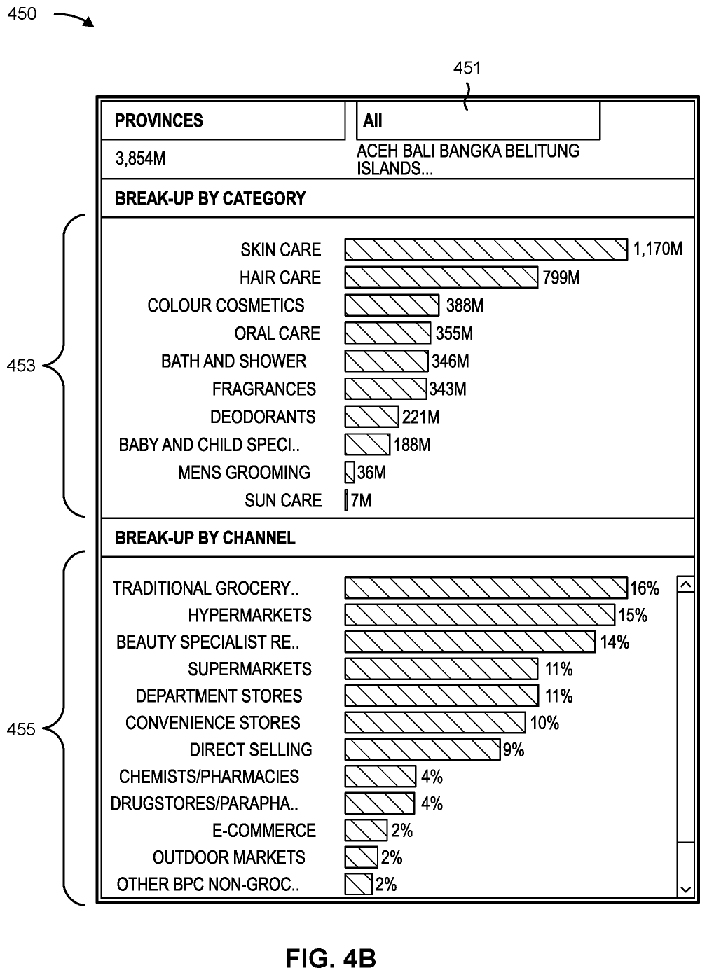

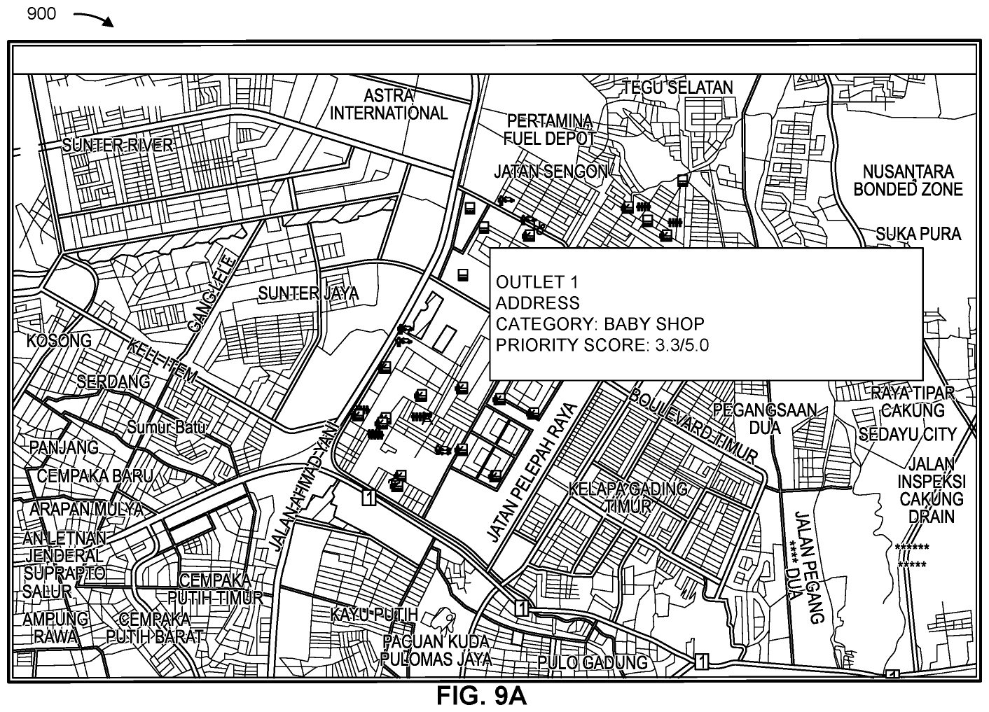

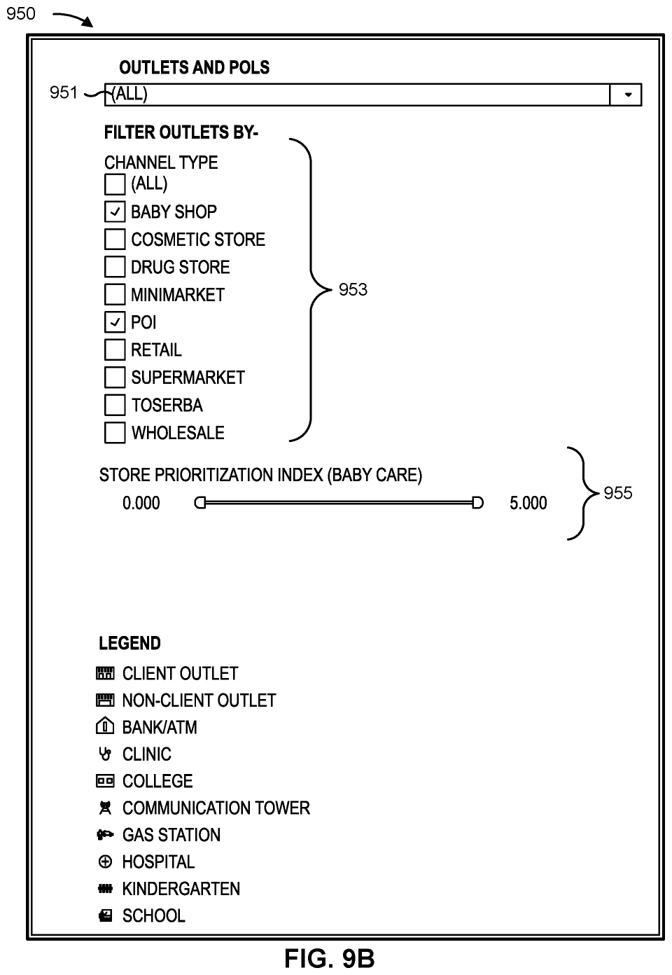

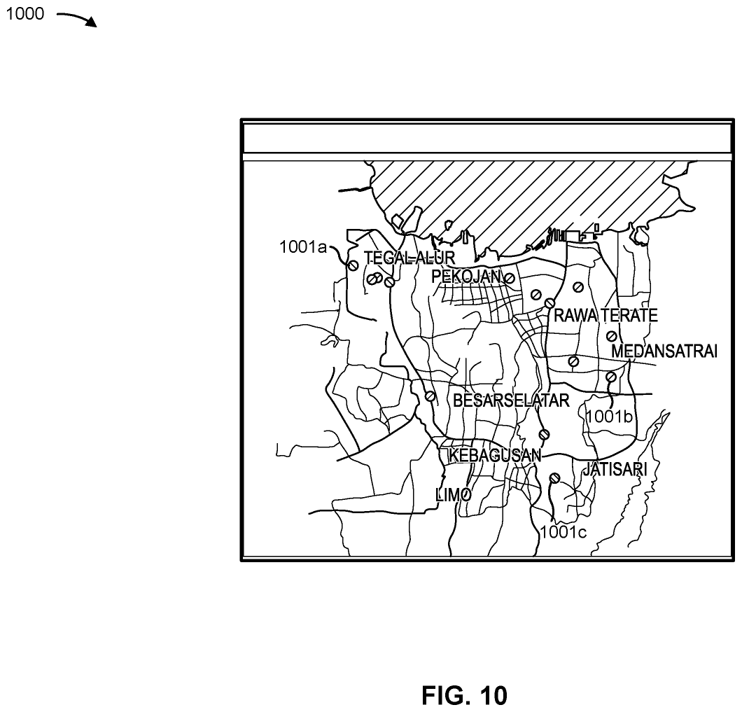

As shown in FIG. 1E and by reference number 150, the data visualizer may generate instructions for displaying a visual representation of the area scores and/or the outlet scores. The visual representation may indicate subarea scores, as shown in FIGS. 4A, 5A, 6A, 7B, and 8B. Alternatively, the visual representation may indicate outlet scores, as shown in FIGS. 9A and 10. Although shown as using patterns to indicate scores, other implementations may use a color range to indicate scores.

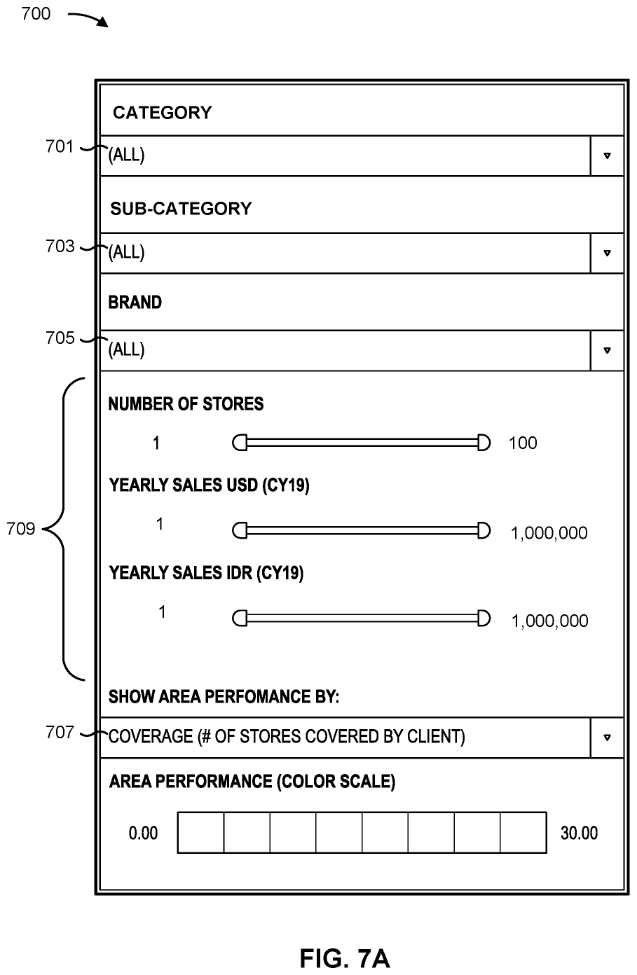

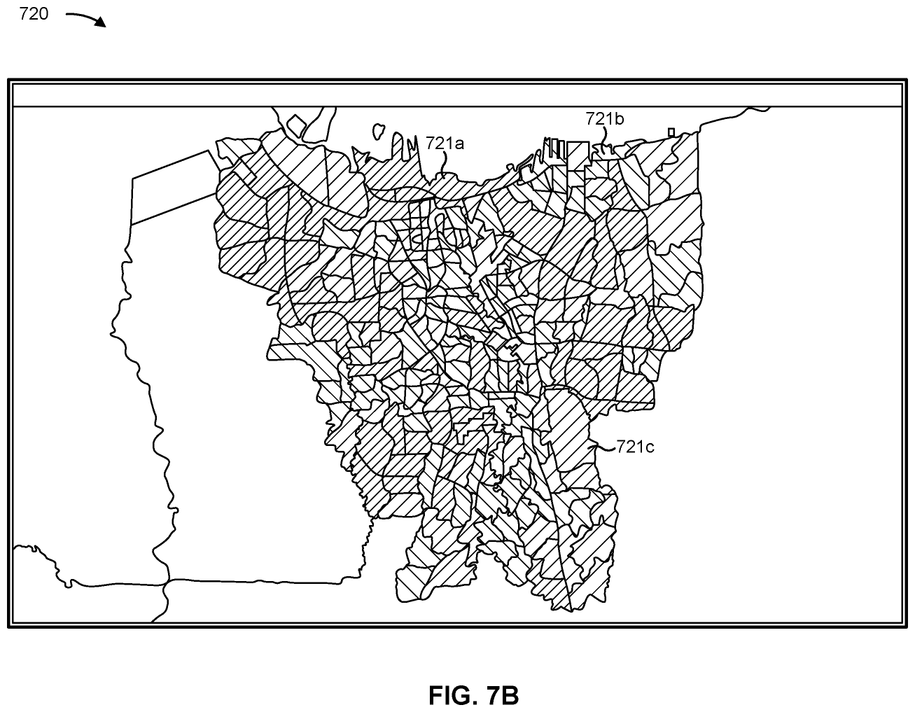

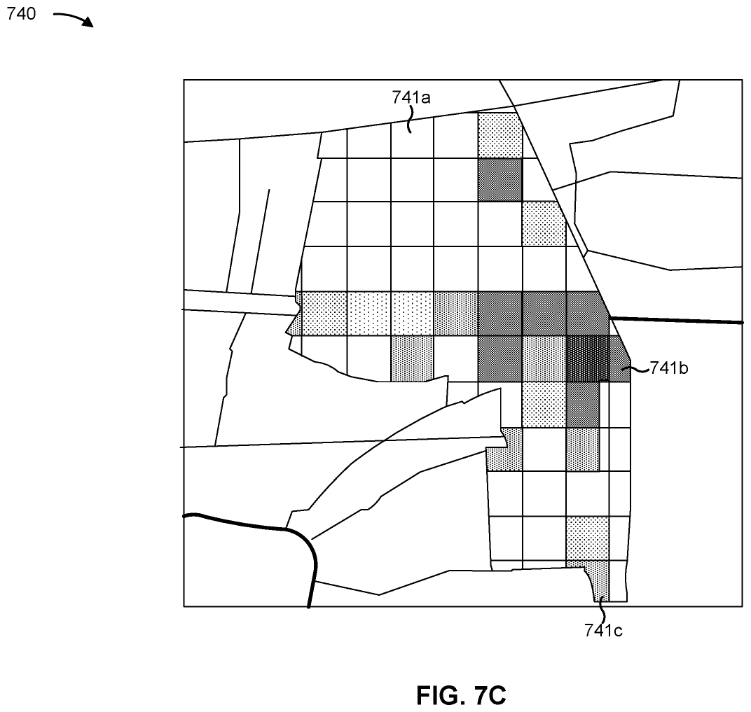

In some implementations, the data visualizer may further generate scores for sub-districts (e.g., similarly as for subareas described above). The sub-districts may comprise cells of a grid overlaid on the area. Accordingly, the visual representation may indicate sub-district scores, as shown in FIG. 7C.

As shown by reference number 155, the data visualizer may transmit, and the user device may receive, the instructions for displaying the visual representation. Accordingly, the data visualizer may cause the user device to display the visual representation.

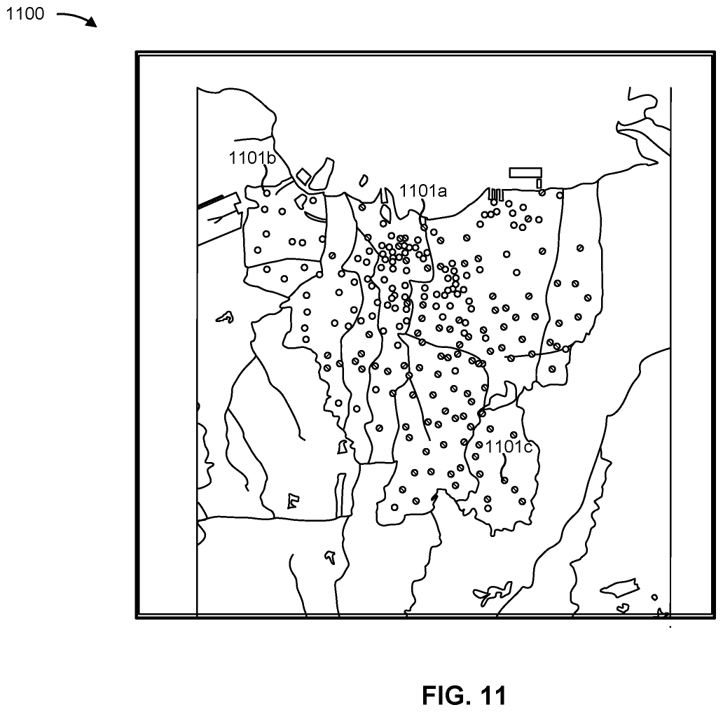

In some implementations, the data visualizer may additionally or alternatively receive a list of distributors with a corresponding set of distributor location indicators. Accordingly, the data visualizer may generate scores (e.g., one or more scores) associated with distributors (e.g., one or more distributors in the list of distributors) based on the tabular data and the factors. For example, the data visualizer may calculate distributor scores similarly as outlet scores described above. Accordingly, the data visualizer may generate instructions for displaying a visual representation of the distributor scores, as shown in FIG. 11. The data visualizer may transmit, and the user device may receive, the instructions for displaying the visual representation such that the data visualizer causes the user device to display the visual representation of the distributor scores.

By using techniques as described in connection with FIGS. 1A-1E, the data visualizer generates subarea scores based on a raster file (or a few raster files) to generate estimates for each subarea rather than receiving and processing separate tables for every subarea. Additionally, the data visualizer generates outlet scores after applying a fuzzy search process that eliminates duplicate outlets. Furthermore, the data visualizer standardizes category tags for the outlets using a combination of master phrases, n-grams, and machine learning. As a result, the data visualizer conserves network resources, power, and processing resources when generating the visual representation associated with subareas by reducing an amount of information that is received and processed. Additionally, the data visualizer conserves power, processing resources, and memory space when generating the visual representation associated with outlets by reducing, or even eliminating, duplicates included in the visualization and thus reducing a size of the instructions for displaying the visual representation. Furthermore, the data visualizer conserves network resources, power, and processing resources when generating the visual representation associated with outlets by reducing a quantity of possible categories and thus reducing a size of the instructions for displaying the visual representation.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

FIGS. 2A-2B are diagrams of an example implementation 200 associated with raster file procedures. As shown in FIGS. 2A-2B, example implementation 200 includes a map database, a shape database, and a data visualizer. These devices are described in more detail below in connection with FIG. 12 and FIG. 13.

As shown in FIG. 2A and by reference number 205, the data visualizer may receive, from the map database, an indication of a statistical distribution (e.g., at least one statistical distribution) associated with a geographic area. As described in connection with FIG. 1A, the map database may be local to the data visualizer (e.g., a cache, a memory, and/or another type of local storage). Alternatively, the map database may be at least partially separate (e.g., physically, logically, and/or virtually) from the data visualizer.

The statistical distribution may be associated with demographic profiles geographic areas (e.g., including the geographic area and optionally neighboring geographic areas). For example, the statistical distribution may indicate population distribution over age-based buckets, income-based buckets, gender-based buckets, or buckets associated with household size, among other examples. The statistical distribution may be based on real values or on ratios (e.g., expressed in percentages, real fractions, or decimal values).

The data visualizer may transmit, to the map database, a request (e.g., a query, an HTTP request, an API call, and/or another type of request) for the statistical distribution (e.g., including an indication of the geographic area or another type of identifier) in order to calculate tabular data (e.g., as described in connection with reference numbers 220 and 225). For example, the data visualizer may receive input (e.g., from a user device) requesting a visualization associated with the geographic area. Accordingly, the data visualizer may transmit the request for the statistical distribution in response to the input requesting the visualization.

In some implementations, the data visualizer may additionally request and receive a raster file (e.g., at least one raster file) from the map database, as described in connection with FIG. 1A. The indication of the statistical distribution may be transmitted with the raster file (e.g., in response to a same request) or separately therefrom (e.g., in response to different requests from the data visualizer). The raster file indicates raster values associated with the geographic area. The statistical distribution may be associated with the same geographic area as the raster file.

As shown by reference number 210, the data visualizer may receive, from the shape database, a shape file (e.g., at least one shape file) indicating a set of polygons. The shape database may be local to the data visualizer (e.g., a cache, a memory, and/or another type of local storage). Alternatively, the shape database may be at least partially separate (e.g., physically, logically, and/or virtually) from the data visualizer. The data visualizer may transmit, to the shape database, a request (e.g., a query, an HTTP request, an API call, and/or another type of request) for the shape file (e.g., including a file name or another type of identifier) in order to process the raster file. For example, the data visualizer may transmit the request for the shape file based on receiving the raster file.

The shape file may be a .xhp file, a .shx file, or a .dbf file, among other examples. The shape file may indicate each polygon using a set of points included in the polygon. Additionally, or alternatively, the shape file may indicate each polygon by indicating boundaries of the polygon (e.g., using points and/or lines that form the boundary).

As shown by reference number 215, the data visualizer may generate a set of masks, based on the set of polygons, to create attribute data. For example, the data visualizer may convert the set of polygons, encoded as vector information in the shape file, to raster information for applying to the raster file. Accordingly, the set of polygons are geometric information that are converted to bitmasks for applying to the raster file. By generating the set of masks, the data visualizer may calculate the attribute data based on raster values included in the raster file. Each value in the attribute data may be associated with a corresponding mask of the set of masks, based on the raster values. For example, to determine an estimate for a polygon, the data visualizer may calculate a summation of raster values included in the mask corresponding to the polygon. In some implementations, the data visualizer may only sum positive raster values.

In some implementations, the attribute data is associated with population or demographic information. For example, the raster file may be associated with population distribution, gender distribution, income distribution, or another type of distribution associated with the geographic area. Accordingly, each value in the attribute data may be a population or demographic estimate associated with a subarea of the geographic area as defined by the mask used to calculate the estimate.

As shown by reference number 220, the data visualizer may standardize the attribute data based on the statistical distribution. For example, the data visualizer may round one or more values of the attribute data up or down to ensure that a portion of the values, corresponding to a subset of the set of polygons, that cover the whole geographic area, sum to an amount indicated by the statistical distribution. Additionally, or alternatively, the data visualizer may adjust one or more values of the attribute data up or down to more closely align a demographic estimate corresponding to a subarea with the statistical distribution for the whole geographic area.

As shown by reference number 225, the data visualizer may generate, and store in the local storage (e.g., a cache or a memory associated with the data visualizer), tabular data based on standardizing the attribute data. For example, the tabular data may include a plurality of entries corresponding to a plurality of subareas of the geographic area, and the data visualizer may populate each entry with a standardized value calculated using a mask that corresponds to the subarea for the entry. In some implementations, the data visualizer may further generate a visualization of the plurality of subareas of the geographic area based on (at least a portion of) the attribute data. For example, the data visualizer may generate the visualization as described in connection with FIGS. 1A-1E.

By using techniques as described in connection with FIGS. 2A-2B, the data visualizer performs raster file processing to calculate the attribute data associated with different subareas of the geographic area. As a result, the data visualizer conserves network resources, power, and processing resources when generating a visualization associated with the subareas by reducing an amount of information that is received and processed. For example, the data visualizer may process one raster file (or a few raster files) to generate the attribute data rather than receiving and processing separate tables for every subarea.

As indicated above, FIGS. 2A-2B are provided as an example. Other examples may differ from what is described with regard to FIGS. 2A-2B. The number and arrangement of devices shown in FIGS. 2A-2B are provided as an example. In practice, there may be additional devices, fewer devices, different devices, or differently arranged devices than those shown in FIGS. 2A-2B. Furthermore, two or more devices shown in FIGS. 2A-2B may be implemented within a single device, or a single device shown in FIGS. 2A-2B may be implemented as multiple, distributed devices. Additionally, or alternatively, a set of devices (e.g., one or more devices) shown in FIGS. 2A-2B may perform one or more functions described as being performed by another set of devices shown in FIGS. 2A-2B.

FIGS. 3A-3B are diagrams of an example implementation 300 associated with fuzzy search procedures. As shown in FIGS. 3A-3B, example implementation 300 includes an outlet database and a data visualizer. These devices are described in more detail below in connection with FIG. 12 and FIG. 13.

As shown in FIG. 3A and by reference number 305, the data visualizer may receive, from a local storage (e.g., a cache or a memory associated with the data visualizer), a list of outlets with a corresponding set of location indicators. The list of outlets may be an existing list of verified names with a corresponding set of verified location indicators. The set of location indicators may include addresses and/or geographic coordinates (e.g., as described in connection with FIG. 1B).

As shown by reference number 310, the data visualizer may receive, from the outlet database, a list of possible outlets with a corresponding set of possible location indicators. The list of possible outlets may be a new list that includes a mix of new outlets and duplicate outlets. The set of possible location indicators may include addresses and/or geographic coordinates.

As shown by reference number 315, the data visualizer may determine a set of buffer zones corresponding to the list of outlets. For example, the data visualizer may calculate, for each outlet in the list of outlets, a radius around the corresponding location indicator for the outlet as the buffer zone corresponding to the outlet. The radius may be based on a default value. Alternatively, a user device may transmit, and the data visualizer may receive, an indication of a value to use for the radius.

As shown in FIG. 3B and by reference number 320, the data visualizer may validate the list of possible outlets against fuzzy match criteria (e.g., one or more fuzzy match criteria). The fuzzy match criteria may include whether a possible outlet is included in a buffer zone associated with an outlet (or is within a distance that satisfies a threshold). Additionally, or alternatively, the fuzzy match criteria may include a match (or a partial match based on character quantities or character percentage) between the location indicator corresponding to a possible outlet and the possible location indicator corresponding to an outlet. Additionally, or alternatively, the fuzzy match criteria may include a match (or a partial match based on character quantities or character percentage) between a name (and/or a description) associated with a possible outlet and a name (and/or a description) associated with an outlet. In some implementations, the fuzzy match criteria may be applied sequentially. For example, addresses, names, and/or descriptions may be compared only when a possible outlet is included within a buffer zone. In another example, subsequent matching thresholds may be increased or decreased based on preceding matching outcomes, such as increasing a threshold for an address match when a possible outlet is not within a threshold of a buffer zone or increasing a size of a buffer zone when a name match is detected. Alternatively, the fuzzy match criteria may be applied holistically. For example, a model may calculate a matching score based on a buffer zone, a name comparison, an address comparison, and/or a description comparison. Accordingly, a match is detected when the matching score satisfies a threshold.

As shown by reference number 325a, the data visualizer may discard possible outlets as duplicate outlets based on the set of buffer zones and the fuzzy match criteria. For example, the data visualizer may discard as duplicate outlets any possible outlets included in buffer zones and/or satisfying the fuzzy match criteria. Moreover, as shown by reference number 325b, the data visualizer may classify possible outlets as new outlets based on the set of buffer zones and the fuzzy match criteria. For example, the data visualizer may classify as new outlets any possible outlets outside buffer zones and/or failing to satisfy the fuzzy match criteria. In some implementations, the data visualizer may further a category tag for the new outlets based on a master phrase, an n-gram, or machine learning, as described in connection with FIG. 1C.

By using techniques as described in connection with FIGS. 3A-3B, the data visualizer eliminates duplicate outlets. As a result, the data visualizer conserves power, processing resources, and memory space when generating a visualization associated with the outlets (e.g., as described in connection with FIGS. 1A-1E) by reducing, or even eliminating, duplicates included in the visualization. Furthermore, fewer duplicates results in smaller instructions for displaying the visualization, and thus the data visualizer conserves network resources in transmitting the instructions to a user device.

As indicated above, FIGS. 3A-3B are provided as an example. Other examples may differ from what is described with regard to FIGS. 3A-3B. The number and arrangement of devices shown in FIGS. 3A-3B are provided as an example. In practice, there may be additional devices, fewer devices, different devices, or differently arranged devices than those shown in FIGS. 3A-3B. Furthermore, two or more devices shown in FIGS. 3A-3B may be implemented within a single device, or a single device shown in FIGS. 3A-3B may be implemented as multiple, distributed devices. Additionally, or alternatively, a set of devices (e.g., one or more devices) shown in FIGS. 3A-3B may perform one or more functions described as being performed by another set of devices shown in FIGS. 3A-3B.

FIGS. 4A, 4B, 5A, 5B, 6A, 6B, 7A, 7B, and 7C are diagrams of example visualizations 400, 450, 500, 550, 600, 650, 700, 720, and 740, respectively, associated with geographic subareas. Example visualizations 400, 450, 500, 550, 600, 650, 700, 720, and 740 may be generated by a data visualizer and transmitted to a user device. These devices are described in more detail below in connection with FIG. 12 and FIG. 13.

As shown in FIG. 4A, the example visualization 400 may represent a plurality of subareas (e.g., subareas 401a, 401b, and 401c, among other examples, in FIG. 4A). In some implementations, the subareas may be represented with patterns (and/or colors) associated with corresponding subarea scores. In the example visualization 400, different patterns correspond to different market potential scores. Accordingly, the data visualizer may generate the subarea scores (e.g., as described in connection with FIGS. 1A-1E), and the user device may display the example visualization 400 based on instructions from the data visualizer. In FIG. 4A, scores represented in the example visualization 400 are based on market potential.

As shown in FIG. 4B, the example visualization 450 may include a selector element 451, such as a drop-down menu. The selector element 451 may allow a user (e.g., using the user device) to select from a plurality of subareas (e.g., the subareas 401a, 401b, and 401c, among other examples, from FIG. 4A). Accordingly, the example visualization 450 may include a list of relevant attributes for the selected subarea (e.g., as shown in portion 453 of FIG. 4B). For example, the data visualizer may extract geo-spatial attributes and/or socio-demographic attributes associated with the selected subarea from tabular data (e.g., as described in connection with FIG. 1A-1E) for display to the user (e.g., via the user device). Additionally, or alternatively, the example visualization 450 may indicate outlets included in the selected subarea (e.g., by category, as shown in portion 455 of FIG. 4B). For example, the data visualizer may determine which outlets, in a list of outlets (e.g., as described in connection with FIG. 1A-1E), are associated with the selected subarea for display to the user (e.g., via the user device). In FIG. 4B, attributes represented in the example visualization 450 are market sizes, and outlets represented in the example visualization 450 are aggregated by category.

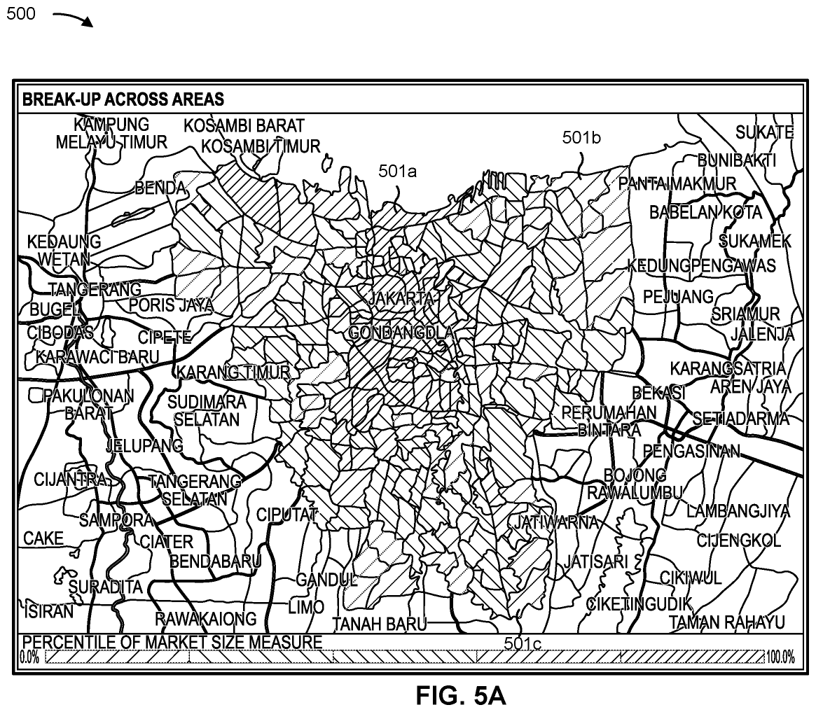

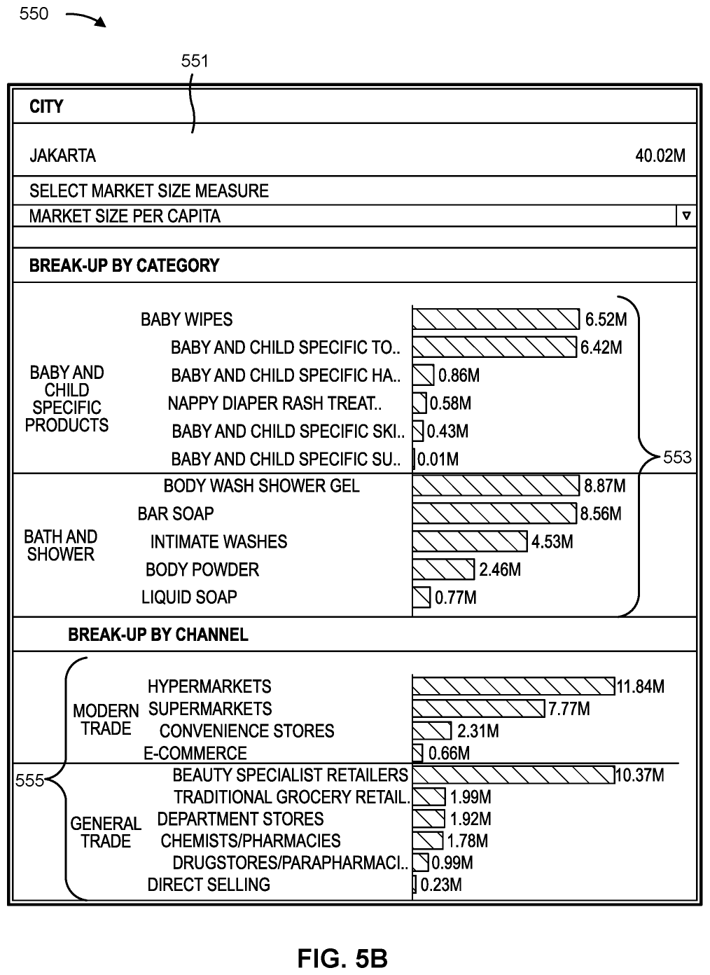

FIG. 5A shows an example visualization 500 that is similar to the example visualization 400. The example visualization 500 may represent a plurality of subareas (e.g., subareas 501a, 501b, and 501c, among other examples, in FIG. 5A). In some implementations, the subareas may be represented with patterns (and/or colors) associated with corresponding subarea scores. In the example visualization 500, different patterns correspond to different market sizes. Accordingly, the data visualizer may generate the subarea scores (e.g., as described in connection with FIGS. 1A-1E), and the user device may display the example visualization 500 based on instructions from the data visualizer. In FIG. 5A, scores represented in the example visualization 500 are based on market size.

FIG. 5B shows an example visualization 550 that is similar to the example visualization 450. The example visualization 550 may include a selector element 551, such as a drop-down menu. The selector element 551 may allow a user (e.g., using the user device) to select from a plurality of subareas (e.g., the subareas 501a, 501b, and 501c, among other examples, from FIG. 5A). Accordingly, the example visualization 550 may include a list of relevant attributes for the selected subarea (e.g., as shown in portion 553 of FIG. 5B). For example, the data visualizer may extract geo-spatial attributes and/or socio-demographic attributes associated with the selected subarea from tabular data (e.g., as described in connection with FIG. 1A-1E) for display to the user (e.g., via the user device). Additionally, or alternatively, the example visualization 550 may indicate outlets included in the selected subarea (e.g., by category, as shown in portion 555 of FIG. 5B). For example, the data visualizer may determine which outlets, in a list of outlets (e.g., as described in connection with FIG. 1A-1E), are associated with the selected subarea for display to the user (e.g., via the user device). In FIG. 5B, attributes represented in the example visualization 550 are market sizes, and outlets represented in the example visualization 550 are aggregated by subcategory.

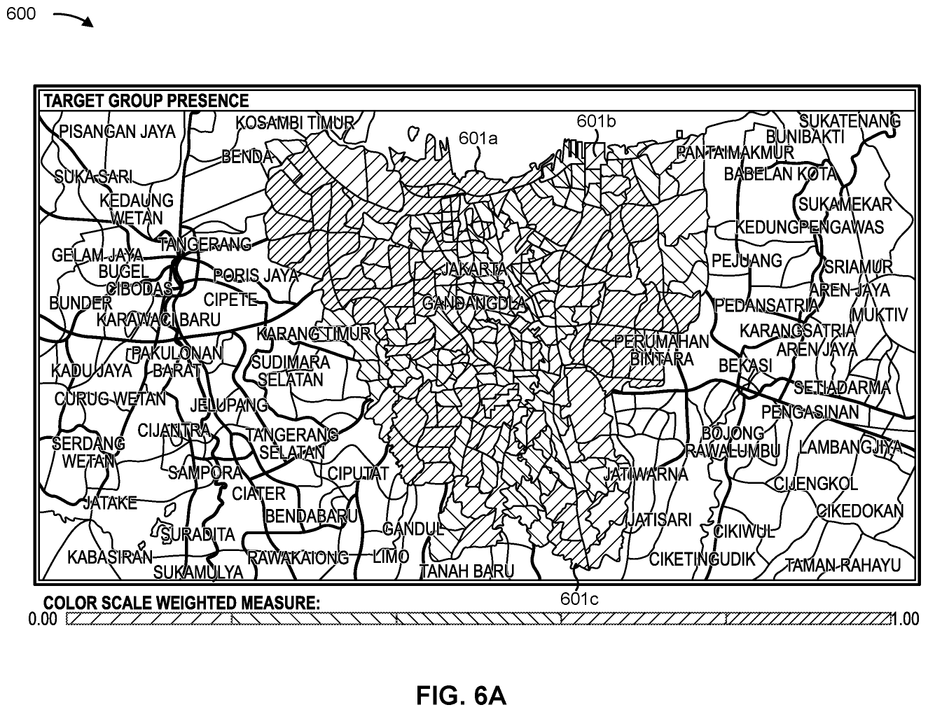

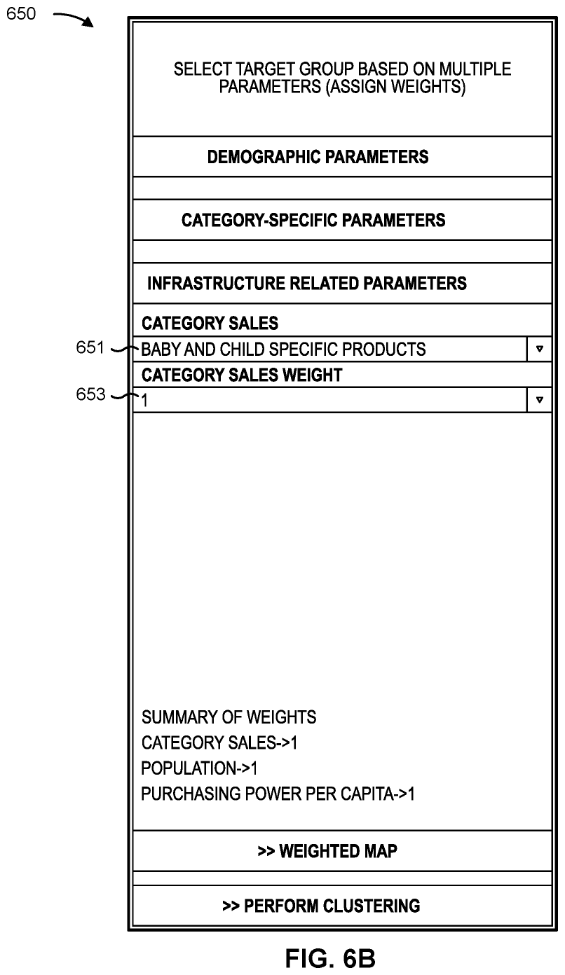

FIG. 6A shows an example visualization 600 that is similar to the example visualization 400. The example visualization 600 may represent a plurality of subareas (e.g., subareas 601a, 601b, and 601c, among other examples, in FIG. 6A). In some implementations, the subareas may be represented with patterns (and/or colors) associated with corresponding subarea scores. In the example visualization 600, different patterns correspond to different market sizes. Accordingly, the data visualizer may generate the subarea scores (e.g., as described in connection with FIGS. 1A-1E), and the user device may display the example visualization 600 based on instructions from the data visualizer. In FIG. 6A, scores represented in the example visualization 600 are based on target demographics.

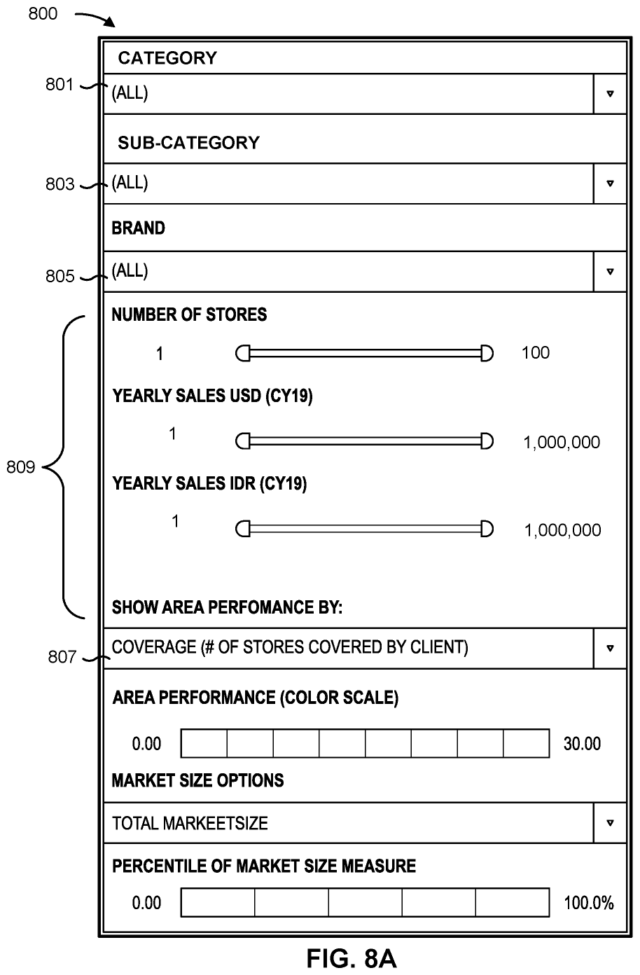

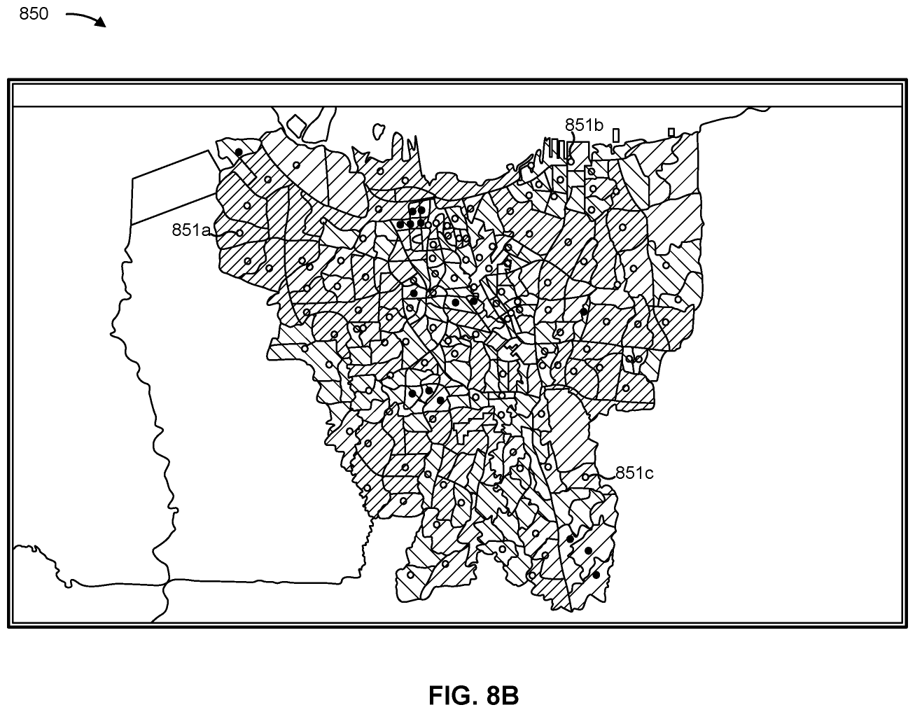

As shown in FIG. 6B, the example visualization 650 may include a selector element 651, such as a drop-down menu. The selector element 651 may allow a user (e.g., using the user device) to select from a plurality of possible factors (e.g., selecting from geo-spatial attributes and/or socio-demographic attributes, as described in connection with FIG. 1D). Additionally, in some implementations, the example visualization 650 may include a selector element 653, such as a drop-down menu. The selector element 653 may allow a user (e.g., using the user device) to select from a weight to associated with the selected factor (e.g., to apply during scoring, as described in connection with FIG. 1D). Accordingly, the example visualization 650 may allow the user to request a visualization with scores based on selected factors and weights, such as the example visualization 600 of FIG. 6A or an outlet-based visualization as shown in FIGS. 8B, 9A, and 10.

FIG. 7A shows an example visualization 700 that is similar to the example visualization 650. The example visualization 700 may include one or more selector elements (e.g., elements 701, 703, 705, and 707), such as drop-down menus. The selector elements 701, 703, 705, and 707 may allow a user (e.g., using the user device) to select from a plurality of possible factors (e.g., selecting from geo-spatial attributes and/or socio-demographic attributes, as described in connection with FIG. 1D). In the example visualization 700, the selector element 701 is associated with outlet categories, the selector element 703 is associated with outlet subcategories, the selector element 705 is associated with outlet groups (e.g., by brand), and the selector element 707 is associated with factors for calculating subarea scores (e.g., as described in connection with FIGS. 1A-1E). Additionally, in some implementations, the example visualization 700 may include selector element group 709, such as slider bars. The selector element group 709 may allow a user (e.g., using the user device) to select subareas (e.g., by quantity of outlets and/or annual sales in different currencies, among other examples) to include in calculating subarea scores. Accordingly, the example visualization 700 may allow the user to request a visualization with scores based on selected factors and weights, such as the example visualization 750 of FIG. 7B or an outlet-based visualization as shown in FIGS. 8B, 9A, and 10.

FIG. 7B shows an example visualization 720 that is similar to the example visualization 400. The example visualization 720 may represent a plurality of subareas (e.g., subareas 721a, 721b, and 721c, among other examples, in FIG. 7B). In some implementations, the subareas may be represented with patterns (and/or colors) associated with corresponding subarea scores. In the example visualization 720, different patterns correspond to different subarea scores (e.g., based on factors selected using the example visualization 700). Accordingly, the data visualizer may generate the subarea scores (e.g., as described in connection with FIGS. 1A-1E), and the user device may display the example visualization 720 based on instructions from the data visualizer. In some implementations, the example visualization 720 may represent subareas based on aggregated outlet scores within the subareas (e.g., based on factors selected using the example visualization 700 and calculated as described in connection with FIGS. 1A-1E).

FIG. 7C shows an example visualization 740 that is similar to the example visualization 720. The example visualization 740 may represent a plurality of sub-districts (e.g., sub-districts 741a, 741b, and 741c, among other examples, in FIG. 7C) that correspond to cells in a grid overlaid on a subarea (e.g., a subarea from the example visualization 720). In some implementations, the sub-districts may be represented with patterns (and/or colors) associated with corresponding sub-district scores. In the example visualization 740, different patterns correspond to different sub-district scores (e.g., based on factors selected using the example visualization 700). Accordingly, the data visualizer may generate the sub-district scores (e.g., as described in connection with FIGS. 1A-1E), and the user device may display the example visualization 740 based on instructions from the data visualizer. In some implementations, the example visualization 740 may represent sub-districts based on aggregated outlet scores within the sub-districts (e.g., based on factors selected using the example visualization 700 and calculated as described in connection with FIGS. 1A-1E).

As indicated above, FIGS. 4A, 4B, 5A, 5B, 6A, 6B, 7A, 7B, and 7C are provided as examples. Other examples may differ from what is described with regard to FIGS. 4A, 4B, 5A, 5B, 6A, 6B, 7A, 7B, and 7C.

FIGS. 8A, 8B, 9A, 9B, and 10 are diagrams of example visualizations 800, 850, 900, 950, and 1000, respectively, associated with outlets. Example visualizations 800, 850, 900, 950, and 1000 may be generated by a data visualizer and transmitted to a user device. These devices are described in more detail below in connection with FIG. 12 and FIG. 13.

FIG. 8A shows an example visualization 800 that is similar to the example visualization 700. The example visualization 800 may include one or more selector elements (e.g., elements 801, 803, 805, and 807), such as drop-down menus. The selector elements 801, 803, 805, and 807 may allow a user (e.g., using the user device) to select from a plurality of possible factors (e.g., selecting from geo-spatial attributes and/or socio-demographic attributes, as described in connection with FIG. 1D). In the example visualization 800, the selector element 801 is associated with outlet categories, the selector element 803 is associated with outlet subcategories, the selector element 805 is associated with outlet groups (e.g., by brand), and the selector element 807 is associated with factors for calculating outlet scores (e.g., as described in connection with FIGS. 1A-1E). Additionally, in some implementations, the example visualization 800 may include selector element group 809, such as slider bars. The selector element group 809 may allow a user (e.g., using the user device) to select subareas (e.g., by quantity of outlets and/or annual sales in different currencies, among other examples) to include in calculating outlet scores. Accordingly, the example visualization 800 may allow the user to request a visualization with scores based on selected factors and weights, such as the example visualization 850 of FIG. 8B or a subarea-based visualization as shown in FIGS. 4A, 5A, 6A, and 7B.

FIG. 8B shows an example visualization 850 that is similar to the example visualization 750. The example visualization 850 may represent a plurality of subareas (e.g., subareas 851a, 851b, and 851c, among other examples, in FIG. 8B). In some implementations, the subareas may be represented with patterns (and/or colors) associated with corresponding outlets scores in the subareas. In the example visualization 850, different patterns correspond to different outlet scores (e.g., based on factors selected using the example visualization 800). Accordingly, the data visualizer may generate the outlet scores (e.g., as described in connection with FIGS. 1A-1E), and the user device may display the example visualization 850 based on instructions from the data visualizer. Therefore, the example visualization 850 may represent subareas based on aggregated outlet scores within the subareas (e.g., based on factors selected using the example visualization 800 and calculated as described in connection with FIGS. 1A-1E).

As shown in FIG. 9A, example visualization 900 may show multiple outlets and display a pop-up with information about an outlet (including a name, a location indicator, a category tag, and an outlet score). For example, a user (e.g., via the user device) may interact with a visual indicator of the outlet (e.g., by clicking or tapping thereon) such that the pop-up with the information is displayed in response to the interaction.

As shown in FIG. 9B, example visualization 950 may include a selector element 951, such as drop-down menus, a selector element group 953, such as check boxes, and/or a selector element group 955, such as slider bars. The selector element 951 may allow a user (e.g., using the user device) to select particular outlets (e.g., by brand or name), the selector element group 953 may allow the user (e.g., using the user device) to select outlets by category, and the selector element group 955 may allow the user (e.g., using the user device) to select an outlet score range. Accordingly, the example visualization 950 may allow the user to request a visualization that displays a subset, out of the list of outlets associated with a subarea, such as the example visualization 900 of FIG. 9A or a subarea-based visualization as shown in FIGS. 4A, 5A, 6A, and 7B.

As shown in FIG. 10, example visualization 1000 may show outlets (e.g., outlets 1001a, 1001b, and 1001c, among other examples, in FIG. 10) associated with outlet scores that satisfy an outlet score threshold. Accordingly, the example visualization 1000 may show a highest scored subset out of the list of outlets associated with a subarea.

As indicated above, FIGS. 8A, 8B, 9A, 9B, and 10 are provided as examples. Other examples may differ from what is described with regard to FIGS. 8A, 8B, 9A, 9B, and 10.

FIG. 11 is a diagram of an example visualization 1100 associated with distributors. Example visualization 1100 may be generated by a data visualizer and transmitted to a user device. These devices are described in more detail below in connection with FIG. 12 and FIG. 13.

As shown in FIG. 11, the example visualization 1100 may represent a plurality of distributors (e.g., distributors 1101a, 1101b, and 1101c, among other examples, in FIG. 11). In some implementations, the distributors may be represented with patterns (and/or colors) associated with corresponding distributors scores. In the example visualization 1100, different patterns correspond to different distributor scores. Accordingly, the data visualizer may generate the distributor scores (e.g., as described in connection with FIGS. 1A-1E), and the user device may display the example visualization 1100 based on instructions from the data visualizer.

As indicated above, FIG. 11 is provided as an example. Other examples may differ from what is described with regard to FIG. 11.

FIG. 12 is a diagram of an example environment 1200 in which systems and/or methods described herein may be implemented. As shown in FIG. 12, environment 1200 may include a data visualizer 1201, which may include one or more elements of and/or may execute within a cloud computing system 1202. The cloud computing system 1202 may include one or more elements 1203-1212, as described in more detail below. As further shown in FIG. 12, environment 1200 may include a network 1220, a device implementing a map database 1230, a device implementing an outlet database 1240, a device implementing a shape database 1250, and/or a user device 1260. Devices and/or elements of environment 1200 may interconnect via wired connections and/or wireless connections.

The cloud computing system 1202 may include computing hardware 1203, a resource management component 1204, a host operating system (OS) 1205, and/or one or more virtual computing systems 1206. The cloud computing system 1202 may execute on, for example, an Amazon Web Services platform, a Microsoft Azure platform, or a Snowflake platform. The resource management component 1204 may perform virtualization (e.g., abstraction) of computing hardware 1203 to create the one or more virtual computing systems 1206. Using virtualization, the resource management component 1204 enables a single computing device (e.g., a computer or a server) to operate like multiple computing devices, such as by creating multiple isolated virtual computing systems 1206 from computing hardware 1203 of the single computing device. In this way, computing hardware 1203 can operate more efficiently, with lower power consumption, higher reliability, higher availability, higher utilization, greater flexibility, and lower cost than using separate computing devices.

The computing hardware 1203 may include hardware and corresponding resources from one or more computing devices. For example, computing hardware 1203 may include hardware from a single computing device (e.g., a single server) or from multiple computing devices (e.g., multiple servers), such as multiple computing devices in one or more data centers. As shown, computing hardware 1203 may include one or more processors 1207, one or more memories 1208, and/or one or more networking components 1209. Examples of a processor, a memory, and a networking component (e.g., a communication component) are described elsewhere herein.

The resource management component 1204 may include a virtualization application (e.g., executing on hardware, such as computing hardware 1203) capable of virtualizing computing hardware 1203 to start, stop, and/or manage one or more virtual computing systems 1206. For example, the resource management component 1204 may include a hypervisor (e.g., a bare-metal or Type 1 hypervisor, a hosted or Type 2 hypervisor, or another type of hypervisor) or a virtual machine monitor, such as when the virtual computing systems 1206 are virtual machines 1210. Additionally, or alternatively, the resource management component 1204 may include a container manager, such as when the virtual computing systems 1206 are containers 1211. In some implementations, the resource management component 1204 executes within and/or in coordination with a host operating system 1205.

A virtual computing system 1206 may include a virtual environment that enables cloud-based execution of operations and/or processes described herein using computing hardware 1203. As shown, a virtual computing system 1206 may include a virtual machine 1210, a container 1211, or a hybrid environment 1212 that includes a virtual machine and a container, among other examples. A virtual computing system 1206 may execute one or more applications using a file system that includes binary files, software libraries, and/or other resources required to execute applications on a guest operating system (e.g., within the virtual computing system 1206) or the host operating system 1205.

Although the data visualizer 1201 may include one or more elements 1203-1212 of the cloud computing system 1202, may execute within the cloud computing system 1202, and/or may be hosted within the cloud computing system 1202, in some implementations, the data visualizer 1201 may not be cloud-based (e.g., may be implemented outside of a cloud computing system) or may be partially cloud-based. For example, the data visualizer 1201 may include one or more devices that are not part of the cloud computing system 1202, such as device 1300 of FIG. 13, which may include a standalone server or another type of computing device. The data visualizer 1201 may perform one or more operations and/or processes described in more detail elsewhere herein.

The network 1220 may include one or more wired and/or wireless networks. For example, the network 1220 may include a cellular network, a public land mobile network (PLMN), a local area network (LAN), a wide area network (WAN), a private network, the Internet, and/or a combination of these or other types of networks. The network 1220 enables communication among the devices of the environment 1200.

The map database 1230 may be implemented on one or more devices capable of receiving, generating, storing, processing, and/or providing information associated with raster files, as described elsewhere herein. The map database 1230 may be implemented on a communication device and/or a computing device. For example, the map database 1230 may be implemented on a server, a database server, an application server, a client server, a web server, a host server, a proxy server, a virtual server (e.g., executing on computing hardware), a server in a cloud computing system, a device that includes computing hardware used in a cloud computing environment, or a similar type of device.

The outlet database 1240 may be implemented on one or more devices capable of receiving, generating, storing, processing, and/or providing information associated with outlet lists, as described elsewhere herein. The outlet database 1240 may be implemented on a communication device and/or a computing device. For example, the outlet database 1240 may be implemented on a server, a database server, an application server, a client server, a web server, a host server, a proxy server, a virtual server (e.g., executing on computing hardware), a server in a cloud computing system, a device that includes computing hardware used in a cloud computing environment, or a similar type of device.

The shape database 1250 may be implemented on one or more devices capable of receiving, generating, storing, processing, and/or providing information associated with shape files, as described elsewhere herein. The shape database 1250 may be implemented on a communication device and/or a computing device. For example, the shape database 1250 may be implemented on a server, a database server, an application server, a client server, a web server, a host server, a proxy server, a virtual server (e.g., executing on computing hardware), a server in a cloud computing system, a device that includes computing hardware used in a cloud computing environment, or a similar type of device.

The user device 1260 may include one or more devices capable of receiving, generating, storing, processing, and/or providing information associated with geographic visualizations, as described elsewhere herein. The user device 1260 may include a communication device and/or a computing device. For example, the user device 1260 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 12 are provided as an example. In practice, there may be additional devices and/or networks, fewer devices and/or networks, different devices and/or networks, or differently arranged devices and/or networks than those shown in FIG. 12. Furthermore, two or more devices shown in FIG. 12 may be implemented within a single device, or a single device shown in FIG. 12 may be implemented as multiple, distributed devices. Additionally, or alternatively, a set of devices (e.g., one or more devices) of the environment 1200 may perform one or more functions described as being performed by another set of devices of the environment 1200.

FIG. 13 is a diagram of example components of a device 1300 associated with fuzzy search and raster file procedures. The device 1300 may correspond to a device implementing a map database 1230, a device implementing an outlet database 1240, a device implementing a shape database 1250, and/or a user device 1260. In some implementations, the device implementing the map database 1230, the device implementing the outlet database 1240, the device implementing the shape database 1250, and/or the user device 1260 may include one or more devices 1300 and/or one or more components of the device 1300. As shown in FIG. 13, the device 1300 may include a bus 1310, a processor 1320, a memory 1330, an input component 1340, an output component 1350, and/or a communication component 1360.

The bus 1310 may include one or more components that enable wired and/or wireless communication among the components of the device 1300. The bus 1310 may couple together two or more components of FIG. 13, such as via operative coupling, communicative coupling, electronic coupling, and/or electric coupling. For example, the bus 1310 may include an electrical connection (e.g., a wire, a trace, and/or a lead) and/or a wireless bus. The processor 1320 may include a central processing unit, a graphics processing unit, a microprocessor, a controller, a microcontroller, a digital signal processor, a field-programmable gate array, an application-specific integrated circuit, and/or another type of processing component. The processor 1320 may be implemented in hardware, firmware, or a combination of hardware and software. In some implementations, the processor 1320 may include one or more processors capable of being programmed to perform one or more operations or processes described elsewhere herein.

The memory 1330 may include volatile and/or nonvolatile memory. For example, the memory 1330 may include random access memory (RAM), read only memory (ROM), a hard disk drive, and/or another type of memory (e.g., a flash memory, a magnetic memory, and/or an optical memory). The memory 1330 may include internal memory (e.g., RAM, ROM, or a hard disk drive) and/or removable memory (e.g., removable via a universal serial bus connection). The memory 1330 may be a non-transitory computer-readable medium. The memory 1330 may store information, one or more instructions, and/or software (e.g., one or more software applications) related to the operation of the device 1300. In some implementations, the memory 1330 may include one or more memories that are coupled (e.g., communicatively coupled) to one or more processors (e.g., processor 1320), such as via the bus 1310. Communicative coupling between a processor 1320 and a memory 1330 may enable the processor 1320 to read and/or process information stored in the memory 1330 and/or to store information in the memory 1330.

The input component 1340 may enable the device 1300 to receive input, such as user input and/or sensed input. For example, the input component 1340 may include a touch screen, a keyboard, a keypad, a mouse, a button, a microphone, a switch, a sensor, a global positioning system sensor, an accelerometer, a gyroscope, and/or an actuator. The output component 1350 may enable the device 1300 to provide output, such as via a display, a speaker, and/or a light-emitting diode. The communication component 1360 may enable the device 1300 to communicate with other devices via a wired connection and/or a wireless connection. For example, the communication component 1360 may include a receiver, a transmitter, a transceiver, a modem, a network interface card, and/or an antenna.

The device 1300 may perform one or more operations or processes described herein. For example, a non-transitory computer-readable medium (e.g., memory 1330) may store a set of instructions (e.g., one or more instructions or code) for execution by the processor 1320. The processor 1320 may execute the set of instructions to perform one or more operations or processes described herein. In some implementations, execution of the set of instructions, by one or more processors 1320, causes the one or more processors 1320 and/or the device 1300 to perform one or more operations or processes described herein. In some implementations, hardwired circuitry may be used instead of or in combination with the instructions to perform one or more operations or processes described herein. Additionally, or alternatively, the processor 1320 may be configured to perform one or more operations or processes described herein. Thus, implementations described herein are not limited to any specific combination of hardware circuitry and software.

The number and arrangement of components shown in FIG. 13 are provided as an example. The device 1300 may include additional components, fewer components, different components, or differently arranged components than those shown in FIG. 13. Additionally, or alternatively, a set of components (e.g., one or more components) of the device 1300 may perform one or more functions described as being performed by another set of components of the device 1300.

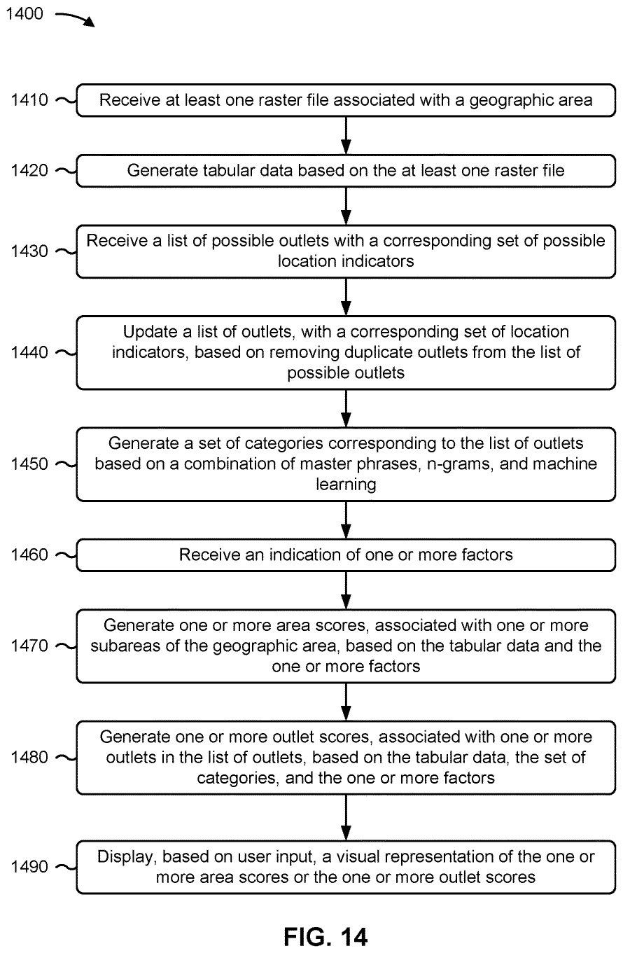

FIG. 14 is a flowchart of an example process 1400 associated with fuzzy search and raster file procedures. In some implementations, one or more process blocks of FIG. 14 are performed by a data visualizer (e.g., data visualizer 1201). In some implementations, one or more process blocks of FIG. 14 are performed by another device or a group of devices separate from or including the data visualizer, such as a device implementing a map database 1230, a device implementing an outlet database 1240, a device implementing a shape database 1250, and/or a user device 1260. Additionally, or alternatively, one or more process blocks of FIG. 14 may be performed by one or more components of device 1300, such as processor 1320, memory 1330, input component 1340, output component 1350, and/or communication component 1360.

As shown in FIG. 14, process 1400 may include receiving at least one raster file associated with a geographic area (block 1410). For example, the data visualizer may receive at least one raster file associated with a geographic area, as described herein.

As further shown in FIG. 14, process 1400 may include generating tabular data based on the at least one raster file (block 1420). For example, the data visualizer may generate tabular data based on the at least one raster file, as described herein.

As further shown in FIG. 14, process 1400 may include receiving a list of possible outlets with a corresponding set of possible location indicators (block 1430). For example, the data visualizer may receive a list of possible outlets with a corresponding set of possible location indicators, as described herein.

As further shown in FIG. 14, process 1400 may include updating a list of outlets, with a corresponding set of location indicators, based on removing duplicate outlets from the list of possible outlets (block 1440). For example, the data visualizer may update a list of outlets, with a corresponding set of location indicators, based on removing duplicate outlets from the list of possible outlets, as described herein.

As further shown in FIG. 14, process 1400 may include generating a set of categories corresponding to the list of outlets based on a combination of master phrases, n-grams, and machine learning (block 1450). For example, the data visualizer may generate a set of categories corresponding to the list of outlets based on a combination of master phrases, n-grams, and machine learning, as described herein.

As further shown in FIG. 14, process 1400 may include receiving an indication of one or more factors (block 1460). For example, the data visualizer may receive an indication of one or more factors, as described herein.

As further shown in FIG. 14, process 1400 may include generating one or more area scores, associated with one or more subareas of the geographic area, based on the tabular data and the one or more factors (block 1470). For example, the data visualizer may generate one or more area scores, associated with one or more subareas of the geographic area, based on the tabular data and the one or more factors, as described herein.

As further shown in FIG. 14, process 1400 may include generating one or more outlet scores, associated with one or more outlets in the list of outlets, based on the tabular data, the set of categories, and the one or more factors (block 1480). For example, the data visualizer may generate one or more outlet scores, associated with one or more outlets in the list of outlets, based on the tabular data, the set of categories, and the one or more factors, as described herein.

As further shown in FIG. 14, process 1400 may include displaying, based on user input, a visual representation of the one or more area scores or the one or more outlet scores (block 1490). For example, the data visualizer may display, based on user input, a visual representation of the one or more area scores or the one or more outlet scores, as described herein.

Process 1400 may include additional implementations, such as any single implementation or any combination of implementations described below and/or in connection with one or more other processes described elsewhere herein.

In a first implementation, process 1400 includes receiving a list of distributors with a corresponding set of distributor location indicators; generating one or more distributor scores, associated with one or more distributors in the list of distributors, based on the tabular data and the one or more factors; and displaying a visual representation of the one or more distributor scores.

In a second implementation, alone or in combination with the first implementation, generating the tabular data based on the at least one raster file includes: generating a set of masks based on a set of polygons to create attribute data; standardizing the attribute data based on statistics associated with the geographic area; and populating the tabular data based on standardizing the attribute data.

In a third implementation, alone or in combination with one or more of the first and second implementations, updating the list of outlets includes, for each outlet in the list of outlets: determining a buffer zone corresponding to the outlet, and removing a possible outlet, from the list of possible outlets, as a duplicate outlet based on a fuzzy match between the possible outlet and the outlet and based on the possible location indicator associated with the possible outlet being included in the buffer zone.

In a fourth implementation, alone or in combination with one or more of the first through third implementations, generating the set of categories includes: tagging a first outlet, from the list of outlets, with a first category based on a description associated with the first outlet including one of the master phrases; tagging a second outlet, from the list of outlets, with a second category based on a description associated with the first outlet including one of the n-grams; and tagging a third outlet, from the list of outlets, with a third category based on output from a machine learning model trained on a set of possible categories.

In a fifth implementation, alone or in combination with one or more of the first through fourth implementations, the set of possible categories is a nested list.

In a sixth implementation, alone or in combination with one or more of the first through fifth implementations, the tabular data includes information regarding geo-spatial attributes associated with the one or more subareas and socio-demographic attributes associated with the one or more subareas.

In a seventh implementation, alone or in combination with one or more of the first through sixth implementations, process 1400 includes receiving one or more weights associated with the one or more factors, where the one or more area scores and the one or more outlet scores are further based on the one or more weights.

In an eighth implementation, alone or in combination with one or more of the first through seventh implementations, the one or more outlet scores are based on information in the tabular data associated with one or more vicinities associated with the one or more outlets.

In a ninth implementation, alone or in combination with one or more of the first through eighth implementations, the visual representation associates the one or more area scores or the one or more outlet scores with a corresponding color range.

Although FIG. 14 shows example blocks of process 1400, in some implementations, process 1400 includes additional blocks, fewer blocks, different blocks, or differently arranged blocks than those depicted in FIG. 14. Additionally, or alternatively, two or more of the blocks of process 1400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving at least one raster file associated with a geographic area;
generating tabular data based on the at least one raster file;
receiving a list of possible outlets with a corresponding set of possible location indicators;
updating a list of outlets, with a corresponding set of location indicators, based on removing duplicate outlets from the list of possible outlets;
generating a set of categories corresponding to the list of outlets based on a combination of master phrases, n-grams, and machine learning;
receiving an indication of one or more factors;
generating one or more area scores, associated with one or more subareas of the geographic area, based on the tabular data and the one or more factors;
generating one or more outlet scores, associated with one or more outlets in the list of outlets, based on the tabular data, the set of categories, and the one or more factors; and
displaying, based on user input, a visual representation of the one or more area scores or the one or more outlet scores.

2. The method of claim 1, further comprising:
receiving a list of distributors with a corresponding set of distributor location indicators;
generating one or more distributor scores, associated with one or more distributors in the list of distributors, based on the tabular data and the one or more factors; and
displaying a visual representation of the one or more distributor scores.

3. The method of claim 1, wherein generating the tabular data based on the at least one raster file comprises:
generating a set of masks based on a set of polygons to create attribute data;
standardizing the attribute data based on statistics associated with the geographic area; and
populating the tabular data based on standardizing the attribute data.

4. The method of claim 1, wherein updating the list of outlets comprises, for each outlet in the list of outlets:
determining a buffer zone corresponding to the outlet; and
removing a possible outlet, from the list of possible outlets, as a duplicate outlet based on a fuzzy match between the possible outlet and the outlet and based on the possible location indicator associated with the possible outlet being included in the buffer zone.

5. The method of claim 1, wherein generating the set of categories comprises:
tagging a first outlet, from the list of outlets, with a first category based on a description associated with the first outlet including one of the master phrases;
tagging a second outlet, from the list of outlets, with a second category based on a description associated with the first outlet including one of the n-grams; and
tagging a third outlet, from the list of outlets, with a third category based on output from a machine learning model trained on a set of possible categories.

6. The method of claim 5, wherein the set of possible categories is a nested list.

7. The method of claim 1, wherein the tabular data includes information regarding geo-spatial attributes associated with the one or more subareas and socio-demographic attributes associated with the one or more subareas.

8. The method of claim 1, further comprising:
receiving one or more weights associated with the one or more factors,
wherein the one or more area scores and the one or more outlet scores are further based on the one or more weights.

9. The method of claim 1, wherein the one or more outlet scores are based on information in the tabular data associated with one or more vicinities associated with the one or more outlets.

10. The method of claim 1, wherein the visual representation associates the one or more area scores or the one or more outlet scores with a corresponding color range.

11. A device, comprising:
one or more memories; and
one or more processors, communicatively coupled to the one or more memories, configured to:
receive an indication of at least one statistical distribution associated with a geographic area;
receive at least one raster file indicating raster values associated with the geographic area;
receive a shape file indicating a set of polygons;
generate a set of masks based on the set of polygons to create attribute data;
standardize the attribute data based on the at least one statistical distribution; and
generate tabular data based on standardizing the attribute data.

12. The device of claim 11, wherein the attribute data is associated with population or demographic information.

13. The device of claim 11, wherein the at least one statistical distribution is associated with demographic profiles across the geographic area and at least one neighboring geographic area.

14. The device of claim 11, wherein the one or more processors are further configured to:
generate a visualization of a plurality of subareas of the geographic area based on at least a portion of the attribute data.

15. The device of claim 11, wherein the one or more processors, to generate the set of masks, are configured to:
determine, for each mask, a summation of positive raster values indicated in the at least one raster file and associated with the mask.

16. A non-transitory computer-readable medium storing a set of instructions, the set of instructions comprising:
one or more instructions that, when executed by one or more processors of a device, cause the device to:
receive a set of outlets with a corresponding set of location indicators;
receive a possible outlet with a corresponding possible location indicator;
determine a set of buffer zones corresponding to the set of outlets; and
classify the possible outlet as a new outlet based on the possible location indicator being located outside the set of buffer zones or based on information associated with the possible outlet failing to satisfy one or more fuzzy match criteria based on a set of information associated with the set of outlets.

17. The non-transitory computer-readable medium of claim 16, wherein the one or more instructions, when executed by the one or more processors, further cause the device to:
generate a category tag for the new outlet based on a master phrase, an n-gram, or machine learning.

18. The non-transitory computer-readable medium of claim 16, wherein the one or more instructions, that cause the device to determine the set of buffer zones, cause the device to:
calculate, for each outlet in the set of outlets, a radius around the corresponding location indicator for the outlet as the buffer zone corresponding to the outlet.

19. The non-transitory computer-readable medium of claim 16, wherein the one or more fuzzy match criteria are associated with a name of the possible outlet or the possible location indicator.

20. The non-transitory computer-readable medium of claim 16, wherein the set of location indicators comprises addresses or geographic coordinates.
